(19) United States
(12) Patent Application Publication
(10) Pub. No.: US 2025/0246941 A1
(43) Pub. Date: Jul. 31, 2025

(54) Wearable Wireless Power Receiver and Walkable Power Transmitter

(71) Applicant: Huawei Digital Power Technologies Co., Ltd., Shenzhen (CN)

(72) Inventors: Fralett Suarez Sandoval, Munich (DE); Sarai Malinal Torres Delgado, Munich (DE)

(21) Appl. No.: 18/978,331

(22) Filed: Dec. 12, 2024

Related U.S. Application Data
(63) Continuation of application No. PCT/EP2022/065987, filed on Jun. 13, 2022.

(51) Int. Cl. H02J 50/70; H02J 50/00; H02J 50/12; H02J 50/40; H02J 50/90

(52) U.S. Cl. CPC H02J 50/70; H02J 50/005; H02J 50/12; H02J 50/402; H02J 50/90

(57) ABSTRACT

A wireless power system for dynamic transfer environments includes a wearable wireless power receiver that may be configured for location at a lower limb of a person and comprises a carrier substrate; and an electrically conductive material mounted at the carrier substrate. The electrically conductive material forms at least one receiver coil. The carrier substrate with the mounted electrically conductive material is formed to adapt to the footwear of the person.

### CROSS-REFERENCE TO RELATED APPLICATIONS

This is a continuation of International Patent Application No. PCT/EP2022/065987, filed on Jun. 13, 2022, the disclosure of which is hereby incorporated by reference in its entirety.

### TECHNICAL FIELD

The disclosure relates to the field of wireless power transfer. In particular, the disclosure relates to a wearable wireless power receiver, a footwear comprising such wearable wireless power receiver, a wearable wireless power receiver arrangement, a wearable coupled resonator array comprising such wearable wireless power receiver, a walkable power transmitter and a method to power wearable electronic devices. The disclosure particularly relates to a wireless power system for dynamic transfer environments.

### BACKGROUND

In available wireless power transfer systems to charge battery-powered devices, the mayor engineering challenge is the reduced positioning freedom of the target device(s). Making this type of technology highly sensitive to lateral or angular misalignments between the transmitter and receiver devices. This causes the problem that the receiver device is not properly charged or even not charged at all in some locations, and in the worst case, the receiver device can actually be damaged when placed in a zone that presents him with a high coupling factor to the transmitter. Another problem of the reduction of the wireless power transfer efficiency due to coupling variations is that most systems require the user to stop using the device when placing it on a charging surface that in some cases has little positioning freedom and in others has some freedom usually on a two-dimensional plane of motion for the receiver.

Some electronic devices have been designed to be worn by the user, for example a device that allows the user to communicate wirelessly to another user while being in a production plant or while working in a grocery store, another example are the head-mounted devices like extended-reality headsets. Supplying to worn devices presents a challenge because they have to be worn for an extended period of time and their batteries have a limited power delivery capability. Increasing the size of the battery or introducing external battery banks supplying to the device comes at the expense of having the user wearing a device that is heavy and uncomfortable. Electrically connecting the device to a power supply reduces the mobility of the user.

### SUMMARY

This disclosure provides a solution for wireless power delivery to wearable electronic devices that is comfortable for the user.

The foregoing and other objects are achieved by the features of the independent claims. Further implementation forms are apparent from the dependent claims, the description and the figures.

The solution presented in this disclosure provides a way of continuously supplying the battery of electronic devices meant to be worn by the user, e.g., around the head area or carried by the user or that are in close contact to him while allowing him to freely move on a designated space while using the device. This problem is solved by employing wireless power transfer systems subjected to a very large-coupling factor variation. Additionally, this disclosure also reveals an alternative wireless power delivery method to an intermediate device of some of the embodiments and application scenarios of this disclosure. Therefore, the solution presented hereinafter can provide power to multiple receiver devices.

The solution presented in this disclosure provides an alternative to a stationary power supply which allows the devices to be used continuously, potentially allowing to reduce the battery size and consequently reducing the overall size and weight of the device to be charged, resulting in a more portable, compact and comfortable fit.

The solution presented herein provides a wireless power transfer system working under the magnetic resonant wireless power transfer principle. The system can be used to supply continuous power to electronic devices that, while in use, require the user to be subjected to a certain mobility range. The system may include the following components such as a transmitter device, a power distribution method, at least one receiver device and the electronic device mounted around the head area requiring power.

The disclosed transmitter device may be placed under the user wearing an enabled wireless power receiver on the lower limb(s) area, for example. The transmitter device can be embodied as an integrated mat containing the power conversion modules or in other implementations the power conversion modules can be located outside the mat, so that the mat can be rolled and easily transported. The disclosure presents the device architecture, coil geometries, fabrication methods and an operating method.

In order to use the power coming from the transmitter, the wireless power enabled receiver can receive the power from the transmitter, convert it from an alternating current (AC) to a direct current (DC) signal, then the power can be distributed to the device requiring charge. In some other implementations, the distribution can happen before the power conversion step.

The use of such a transmitter-receiver system allows to provide a continuous power supply to receiver devices subjected to a high-dynamic range while being worn by the user, in particular, to head-mounted devices like extended reality headsets, thus avoiding the user to carry a heavy battery bank to continuously supply the device being used.

The disclosure presents the system architecture, application scenarios, various types of possible implementations of the transmitter, receiver, and power distribution modules, as well as operating methods.

In order to describe the disclosure in detail, the following terms and notations will be used.

WPT wireless power transfer

PCB printed circuit board

X-reality extended reality

DC direct current

AC alternating current

AC-DC alternating current to direct current converter

DC-DC direct current to direct current converter

In this disclosure, WPT systems are described, in particular one-to-one WPT systems, one-to-many WPT systems, many-to-one WPT systems and many-to-many WPT systems.

One-to-one WPT systems are WPT systems composed by a single transmitter and a single receiver device. One-to-many WPT systems are WPT systems composed by a single transmitter and multiple receiver devices. Many-to-one WPT systems are WPT systems composed by multiple transmitter and a single receiver device. Many-to-many WPT systems are WPT systems composed by multiple transmitter and multiple receiver devices.

In this disclosure, wearable devices, i.e., devices wearable by a user, are described. Such devices include, for example, devices like smartphones, wearables like smartwatches, fitness bands, head-mounted devices like virtual, augmented or mixed reality headsets, and hand-controllers, over-ear headphones, tablets, portable computers, smart glasses, gaming controllers, communication devices like radios, desktop accessories like a mouse or keyboard, battery banks, remote controls, hand-held terminals, e-mobility devices, portable gaming consoles, portable music players, key fobs, drones used in WPT systems that allow a high-degree of freedom of the receiver.

In the context of charging a wearable device, different technologies, such as WPT or wireless charging, contact charging, power sharing and external power supply can be applied. Wireless power transfer is the transmission of electrical energy without the use of wires as a physical link. This technology uses a transmitter device capable of generating a time-varying electromagnetic field that causes a circulating electric field through a receiver device (or devices) based on the principle of electromagnetic induction. The receiver device (or devices) is (are) capable of being supplied directly from this circulating electric field or they convert it to a suitable power level to supply to an electrical load or battery connected to them.

Contact charging, also known as surface charging is another type of cord-free power delivery that uses electrical connection of conductive surfaces between the device providing the power and the device receiving the power.

In power sharing, a battery-powered electronic device can be maintained charged by using an external battery bank or external power supplies being electrically connected to it. This can be implemented by, for example, a battery bank worn concurrently by the user and making an electrical connection to the device that needs to be charged. A similar approach is used to share the available power of another portable device like a smartphone by making an electrical connection between the smartphone and the device.

Further, an electronic device can be continuously charged by electrically connecting to an external DC power supply. In such a situation, the battery inside the device can even be removed and thereby having a continuous supply without requiring a battery.

In the following, wireless power transmission systems are described.

The number of battery-powered electronic devices is increasing rapidly because they provide freedom of movement and portability. These devices should be continuously recharged to ensure they function. Their charging frequency can be diminished by the use of a large battery, but these impact the overall cost of the electronic device, as well as their weight and size.

Charging of battery-powered electronic devices is usually done with the use of a wall charger and a dedicated cable that connects to an input port of the device to be charged to establish an electrical connection between the power supply and the power-hungry device. Some disadvantages of this charging mechanism are summarized as: a) the connector at this input port is susceptible to mechanical failure due to the connection/disconnection cycles required to charge the battery; b) each battery-powered device comes with its dedicated cable and wall charger. These two components function sometimes exclusively with each device and are not interchangeable between devices. This increases the cost of the device and the electronic-waste generated by the non-functional wall chargers and cables; c) the production of waterproof devices becomes more challenging due to the higher cost associated with the enclosure required around the input port of the battery-powered electronic device; and d) the use of a cable restricts the mobility of the user according to the length of the charging cable.

In order to avoid these disadvantages, several methods for WPT to recharge the battery of the electronic device without the use of a charging cable have been recently proposed.

Commercial WPT systems have mainly been driven by two organizations, the WIRELESS POWER CONSORTIUM and the AIRFUEL ALLIANCE. The WIRELESS POWER CONSORTIUM created the Qi Standard to wirelessly charge consumer electronic devices using magnetic induction from a base station, usually a thin mat-like object, containing one or more transmitter inductors and a target device fitted with a receiving inductor. Qi systems require close proximity of the transmitter and receiver devices, usually within a couple of millimeters to a couple of centimeters.

Wireless power transfer systems that function under the AIRFUEL ALLIANCE principle use a resonant inductive coupling between the transmitter inductor and the receiver inductor to consequently charge the battery connected to the receiver device. The resonant coupling allows for the power to be transferred over greater distances. The overall system efficiency is a function of the resonators' quality factor and the coupling factor between their inductive elements.

According to a first aspect, the disclosure relates to a wearable wireless power receiver for receiving an electromagnetic field and transforming the electromagnetic field into electric power for powering a wearable electronic device, the wearable wireless power receiver being configured for location at a lower limb of a person, the wearable wireless power receiver comprising: a carrier substrate; an electrically conductive material mounted at the carrier substrate, the electrically conductive material forming at least one receiver coil, wherein the carrier substrate with the mounted electrically conductive material is formed to adapt to the footwear of the person, wherein the at least one receiver coil is configured to receive an electromagnetic field.

Such a wearable wireless power receiver provides the advantage of supplying power to the wearable electronic device by converting the received wireless power from a transmitter device while the user is comfortably wearing the electronic device. The wearable wireless power receiver allows for a continuous powering of electronic devices that are intended to be worn by the user, e.g., around the head area or carried by the user or that are in close contact to him while allowing him to freely move on a designated space while using the device. The wearable wireless power receiver provides an alternative to a stationary power supply which allows the devices to be used continuously, potentially allowing to reduce the battery size and consequently reducing the overall size and weight of the device to be charged, resulting in a more portable, compact and comfortable fit.

In this context, the term “configured for location at a lower limb” means that the wearable wireless power receiver can be attached, fixed or embedded below, around, inside or within footwear, insoles, outsoles or even clothing at the lower limb of the person for example at the feet and/or ankles area.

In an exemplary implementation of the wearable wireless power receiver, the wearable wireless power receiver comprises a shielding material mounted at the carrier substrate, the shielding material being configured to shield the person from at least a portion of the electromagnetic field.

Such a wearable wireless power receiver provides the advantage of an effective shielding of the person wearing the receiver from the electromagnetic field.

The carrier substrate may comprise a first surface configured to face the person and a second surface opposing the first surface. The shielding material may be mounted at the first surface of the carrier substrate, and the electrically conductive material forming the at least one receiver coil may be mounted at the second surface of the carrier substrate.

In an exemplary implementation of the wearable wireless power receiver, the carrier substrate with the mounted electrically conductive material and with or without the shielding material is formed to be embedded into an outsole of a shoe.

This provides the advantage that the receiver can be flexibly attached and detached from the shoe and can be used if required. The receiver can also be attached to different shoes.

In an exemplary implementation of the wearable wireless power receiver, the carrier substrate with the mounted electrically conductive material and with or without the shielding material is formed to be removably attached to a bottom part of a shoe.

This provides the advantage that the receiver can be flexibly attached and detached from the shoe and can be used if required. The receiver can also be attached to different shoes.

In an exemplary implementation of the wearable wireless power receiver, the carrier substrate with the mounted electrically conductive material and with or without the shielding material is formed to be embedded into an insole of a shoe.

This provides the advantage that the receiver can be put in and taken out of the shoe if required. The receiver can be used with different shoes.

The wearable wireless power receiver may further comprise: a power conversion entity configured to transform the electromagnetic field received by the wireless power receiver into electric power and to provide the electric power via an electric guide to the wearable electronic device.

The wearable wireless power receiver may comprise: an electrical connector for connecting an electrical cable as the electric guide. The electrical connector may be configured to provide the electric power via the electrical cable to the wearable electronic device.

According to a second aspect, the disclosure relates to a footwear for a person, the footwear comprising the wearable wireless power receiver device according to the first aspect.

Such a footwear provides the same advantages as the wearable wireless power receiver described above, i.e., it provides the advantage of supplying power to the wearable electronic device by converting the received wireless power from a transmitter device while the user is comfortably wearing the electronic device. This footwear allows for a continuous powering of electronic devices that are intended to be worn by the user while allowing him to freely move on a designated space while using the device. The footwear provides an alternative to a stationary power supply which allows the devices to be used continuously, potentially allowing to reduce the battery size and consequently to reduce the overall size and weight of the device to be charged, resulting in a more portable, compact and comfortable fit.

According to a third aspect, the disclosure relates to a wearable coupled resonator array comprising, a wearable wireless power receiver according to the first aspect; wherein the wearable coupled resonator array is configured to extend from the footwear of the person to a location of the wearable electronic device or to a location of a second wearable electronic device, wherein the wearable coupled resonator array is configured to receive an electromagnetic field and to relay it from the footwear of the person to the location of the wearable electronic device or to the location of the second wearable electronic device.

Such a wearable coupled resonator array allows for an easy mount, to be worn close to the user's body allowing him to freely move without constraints. It allows the power to be distributed all the way from the lower limb of the user to the device requiring charge. In some implementations directly to a head-mounted device, like extended reality headsets. In some other implementations requiring an external processing unit such as a smartphone, the distribution can happen before the power conversion step and travel in a first step from the lower limb of the user to the user's pocket or wherever such unit is carried and in a second step from the processing unit to the head-mounted device.

The wearable electronic device and/or the second wearable electronic device may comprise a wireless power receiver entity of its own that is configured to receive the electromagnetic field from the coupled resonator array.

According to a fourth aspect, the disclosure relates to a wearable wireless power receiver arrangement for powering at least one of a wearable electronic device or a second wearable electronic device, the wearable wireless power receiver arrangement comprising: a wearable wireless power receiver according to the first aspect, a footwear according to the second aspect, or a wearable coupled resonator array according to the third aspect, being configured for location at a lower limb of a person; a wearable electronic device and/or a second wearable electronic device configured to be powered by the wearable wireless power receiver; and an electric guide configured to transport the electric power from at least one of the wearable wireless power receiver and the second wearable electronic device to at least one of the wearable electronic device and the second wearable electronic device.

Such a wearable wireless power receiver arrangement provides the advantage of an efficient power delivery of the received wireless power to wearable electronic devices that is comfortable for the user. The wearable wireless power receiver arrangement allows for a continuous powering of electronic devices that can be worn by the user while allowing him to freely move on a designated space while using the device. The wearable wireless power receiver arrangement provides an alternative to a stationary power supply which allows the devices to be used continuously, potentially allowing to reduce the battery size and consequently to reduce the overall size and weight of the device to be charged, resulting in a more portable, compact and comfortable fit.

In an exemplary implementation of the wearable wireless power receiver arrangement, the second wearable electronic device is configured to charge itself with part of the electric power and forward the rest of the electric power received via a first electric guide from the wearable wireless power receiver via a second electric guide to the wearable electronic device.

This provides the advantage of flexible charging multiple electronic devices. The electric power from the receiver can be advantageously relayed between the multiple electronic devices.

In an exemplary implementation of the wearable wireless power receiver arrangement, the second wearable electronic device comprises a wireless power receiver entity that is configured to receive the electromagnetic field from a coupled resonator array, convert the electromagnetic field into electric power, charge itself with part of the electric power, and/or forward the remaining part of the electric power via an electric guide to the wearable electronic device.

This provides the advantage of flexible charging multiple electronic devices. The electric power can be flexible received from the wireless power receiver or from a coupled resonator array.

In an exemplary implementation of the wearable wireless power receiver arrangement, the wearable wireless power receiver arrangement comprises: a second wearable wireless power receiver according to the first aspect, the second wearable wireless power receiver being attachable to a second footwear of the person for powering at least one wearable electronic device.

This provides the advantage that since the person has two feet and can wear a wireless power receiver, the received power is increased. The wearable wireless power receiver arrangement may comprise: a power combiner configured to combine the electric powers from the wearable wireless power receiver and the second wearable wireless power receiver for powering the wearable electronic device and/or the second wearable electronic device with the combined electric power of both wearable wireless power receivers.

According to a fifth aspect, the disclosure relates to a walkable power transmitter for powering at least one of a wearable electronic device and a second wearable electronic device through the use of a wearable wireless power receiver arrangement according to the fourth aspect, the walkable power transmitter comprising: a power source; a carrier substrate; an electrically conductive material mounted at the carrier substrate, the electrically conductive material forming at least one transmitter coil, wherein the carrier substrate with the mounted electrically conductive material is formed to adapt to a floor walkable by a person, wherein the at least one transmitter coil is configured to transmit an electromagnetic field for powering at least one of a wearable electronic device and a second wearable electronic device.

Such a walkable power transmitter provides the following advantages: the transmitter can be laid on the floor and can be used in most places, environments and possible scenarios, provided that it can be plugged to the main line. The transmitter allows the user to freely move on a designated space, for example, over a mat, while using and continuously supplying the battery of an electronic device. When it is made flexible, allowing even rolling it for easy transportation, as a portable device.

In this context, the term “walkable/walking” means that a person can walk on or over the power transmitter, the person can have his feet on the power transmitter, e.g., when sitting on a chair next to the power transmitter. The power transmitter can be below a table and the person can put his feet on the power transmitter.

The term “walkable/walking” also includes the meaning of “steppable/stepping”, i.e., being able to be stepped on or over. “Walkable/walking” here means the capability of being walked on or over; real walking by the person on or over the transmitter can happen but does not have to take place.

In an exemplary implementation of the walkable power transmitter, the walkable power transmitter comprises a shielding material mounted at the carrier substrate, the shielding material being configured to shield the floor from the power transmitter and vice versa.

Such a walkable power transmitter provides the advantage of an effective shielding of the floor from the electromagnetic field.

The carrier substrate may comprise a first surface configured to face the person and a second surface opposing the first surface. The shielding material may be mounted at the second surface of the carrier substrate, and the electrically conductive material forming the at least one transmitter coil may be mounted at the first surface of the carrier substrate.

In an exemplary implementation of the walkable power transmitter, the carrier substrate with the mounted electrically conductive material is formed to be embedded in a mat that can be laid on the floor; or the carrier substrate with the mounted electrically conductive material is formed to be embedded into the floor.

This provides the advantage of an easy transportation of the walkable power transmitter and application of the walkable power transmitter in different environments. Alternatively, the walkable power transmitter can be embedded in the floor; then it is always available.

In an exemplary implementation of the walkable power transmitter, the carrier substrate with the mounted electrically conductive material extends over a first region onto which the person can place a first foot and a second region onto which the person can place a second foot.

This provides the advantage that the transmitter can efficiently power two receivers, each one worn at a different foot of the person. This results in higher efficiency of power transmission.

In an exemplary implementation of the walkable power transmitter, the walkable power transmitter comprises substrate extensions located at corners of the carrier substrate, the substrate extensions being displaced in height with respect to a main plane of the carrier substrate, wherein the at least one transmitter coil is formed on the carrier substrate and on the substrate extensions.

This provides the advantage of an increased uniformity of the generated electromagnetic field distribution in a direction perpendicular to the main plane.

In an exemplary implementation of the walkable power transmitter, the walkable power transmitter comprises: a flexible mat comprising the carrier substrate with the mounted electrically conductive material and with or without the shielding material, wherein the flexible mat can be rolled and/or folded; and wherein the power source is attached outside the flexible mat.

This provides the advantage of a comfortable usage of the walkable power transmitter since it can be laid upon each floor where the user wants to charge his wearable electronic devices.

The walkable power transmitter may comprise: a case for housing the carrier substrate with the mounted electrically conductive material and with or without the shielding material and the power source.

In an exemplary implementation of the walkable power transmitter, the at least one transmitter coil is configured to generate at least two charging hotspots for powering at least a wearable electronic device and a second wearable electronic device.

This provides the advantage that the user can step on each charging hotspot with a respective receiver and increase the efficiency of power transfer when using two receivers and/or the walkable transmitter can supply to receivers worn by a second user.

The walkable power transmitter may comprise a user interface for remote controlling the walkable power transmitter.

According to a sixth aspect, the disclosure relates to a method for powering a wearable electronic device, the method comprising: enabling a walkable power transmitter according to the fifth aspect; detecting, by the walkable power transmitter, one or more wearable wireless power receivers according to the first aspect; upon detecting a wearable wireless power receiver according to the first aspect, providing, by the walkable power transmitter, an initial power to the wearable wireless power receiver for communicating a pairing mode between the walkable power transmitter and the wearable wireless power receiver; and providing, by the walkable power transmitter, a nominal power to the wearable wireless power receiver for powering at least one of a wearable electronic device and a second wearable electronic device.

Such a method provides the same advantages as the wearable wireless power receiver, the wireless power receiver arrangement, and the walkable transmitter described above, i.e., it provides the advantage of an efficient wireless power transmission of wearable electronic devices that is comfortable for the user. The method allows for a continuous powering of electronic devices that are intended to be worn by the user while allowing him to freely move on a designated space while using the device.

In the following, advantages and advantageous effects are described which can be achieved by the devices, method, systems and arrangements described in this disclosure.

The disclosed devices, method, systems and arrangements and all the disclosed modules in combination, that is, the WPT system for dynamic scenarios and in particular the disclosed transmitter-receiver system; the mat-like WPT transmitter device and the WPT receiver device worn on the user's lower limb(s) area provide the following advantages: They allow to provide continuous power supply to receiver devices subjected to a high-dynamic range while being worn by the user, in particular to head-mounted devices like extended reality headsets. They avoid having to carry a heavy battery bank to continuously supply the device being used. They allow to reduce the battery size and consequently reducing the overall size and weight of the device to be charged, resulting in a more portable, compact and comfortable fit. The problem of large variation coupling factor to which any dynamic scenario is subjected is solved by employing a WPT system working under the magnetic resonant WPT principle.

A mat-like or planar transmitter device according to the disclosure provides the following advantages: The transmitter device can be laid on the floor and can be used in most places, environments and possible scenarios, provided that it can be plugged to the main line. The transmitter device allows the user to freely move on a designated space, for example, over the mat, while using and continuously supplying the battery of an electronic device. When it is made flexible, allowing even rolling it for easy transportation, as a portable device.

A lower-limb wearable receiver device according to the disclosure allows the user to freely move on a designated space while using and continuously supplying the battery of an electronic device. It allows the receiver to be fitted into any shoe and be worn comfortably and safely without constraining the user.

A power distribution/delivery module according to the disclosure allows for an easy mount, to be worn close to the user's body allowing him to freely move without constraints. It allows the power to be distributed all the way from the lower limb of the user to the device requiring charge. In some implementations directly to a head-mounted device, like extended reality headsets. In some other implementations requiring an external processing unit such as a smartphone, the distribution can happen before the power conversion step and travel in a first step from the lower limb of the user to the user's pocket or wherever such unit is carried and in a second step from the processing unit to the head-mounted device. The power distribution can happen in the DC or in the AC domain by the use of a cable or a coupled resonator array. Such a power distribution/delivery module according to the disclosure allows to provide power to multiple receiver devices simultaneously.

### BRIEF DESCRIPTION OF THE DRAWINGS

Further embodiments of the disclosure will be described with respect to the following figures.

FIG. 1 shows a schematic diagram of a WPT system 100 according to the disclosure.

FIG. 2 shows a circuit diagram of the WPT system 100 shown in FIG. 1.

FIG. 3A shows a schematic diagram illustrating a wireless power system according to the disclosure and FIG. 3B, FIG. 3C, and FIG. 3D show possible positions of the wireless power receiver.

FIG. 4A, FIG. 4B, and FIG. 4C show schematic diagrams illustrating three embodiments of the WPT system 100 shown in FIG. 1.

FIG. 5A, FIG. 5B, and FIG. 5C show schematic diagrams illustrating a detailed exemplary implementation of the WPT system 100 shown in FIG. 1.

FIG. 6A, FIG. 6B, and FIG. 6C show schematic diagrams illustrating another detailed exemplary implementation of the WPT system 100 shown in FIG. 1.

FIG. 7A, FIG. 7B, FIG. 7C, and FIG. 7D show schematic diagrams illustrating a further detailed exemplary implementation of the WPT system 100 shown in FIG. 1.

FIG. 8A and FIG. 8B show schematic diagrams illustrating an exemplary scenario where a user is playing a virtual reality game.

FIG. 9A and FIG. 9B show schematic diagrams illustrating an exemplary scenario for assisting a user to perform a certain task with the use of an extended reality headset.

FIG. 10A and FIG. 10B show schematic diagrams illustrating exemplary implementations of a walkable power transmitter according to the disclosure.

FIG. 11A and FIG. 11B show schematic diagrams illustrating exemplary implementations of the shielded magnetic components on the transmitter and the receiver side.

FIG. 12A, FIG. 12B, FIG. 12C, FIG. 12D, FIG. 12E, FIG. 12F, FIG. 12G, and FIG. 12H show exemplary implementations of the inductive element of the walkable power transmitter according to the disclosure.

FIG. 13A and FIG. 13B show schematic diagrams of one-to-many WPT systems 100 according to the disclosure for supplying a wearable electronic device 109.

FIG. 14 shows a schematic diagram illustrating an exemplary implementation of a wearable wireless power receiver 105 according to the disclosure.

FIG. 15 shows a schematic diagram illustrating another exemplary implementation of a wearable wireless power receiver 105 according to the disclosure.

FIG. 16 shows a schematic diagram illustrating a further exemplary implementation of a wearable wireless power receiver 105 according to the disclosure.

FIG. 17 shows a schematic diagram illustrating an exemplary implementation of a footwear with a wearable wireless power receiver 105 according to the disclosure.

FIG. 18A, FIG. 18B, FIG. 18C, FIG. 18D, and FIG. 18E show a schematic diagram illustrating an exemplary implementation of a WPT system with a wearable coupled resonator array 402 according to the disclosure.

FIG. 19A and FIG. 19B show schematic diagrams illustrating an exemplary implementation of a WPT system 100 for providing wireless power to intermediate devices according to the disclosure.

FIG. 20A, FIG. 20B, FIG. 20C, and FIG. 20D show schematic diagrams illustrating exemplary application scenarios for the system 100 of FIG. 19A and FIG. 19B.

FIG. 21 shows a schematic diagram illustrating a method 2100 for powering a wearable electronic device according to the disclosure.

### DETAILED DESCRIPTION OF EMBODIMENTS

In the following detailed description, reference is made to the accompanying drawings, which form a part thereof, and in which is shown by way of illustration aspects in which the disclosure may be practiced. It is understood that other aspects may be utilized and structural or logical changes may be made without departing from the scope of the disclosure. The following detailed description is not to be taken in a limiting sense, and the scope of the disclosure is defined by the appended claims.

It is understood that comments made in connection with a described method may also hold true for a corresponding device or system configured to perform the method and vice versa. For example, if a method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

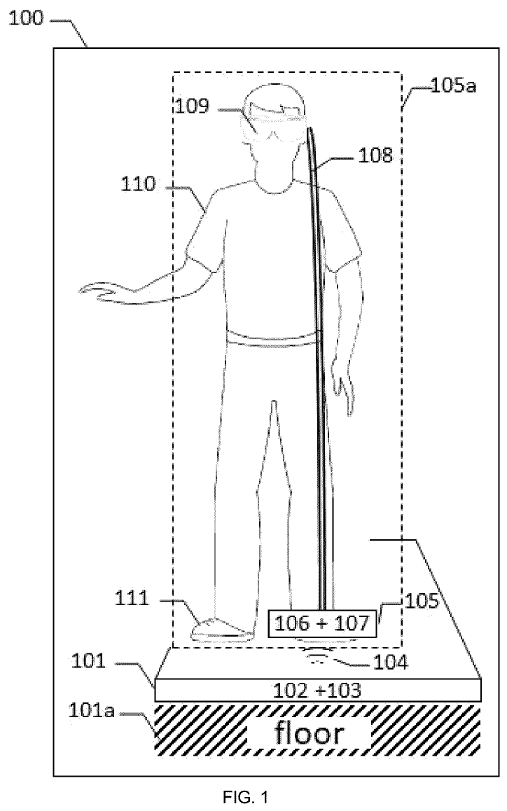

FIG. 1 shows a schematic diagram of a WPT system 100 according to the disclosure.

Such a WPT system 100 may comprise the following components as shown in FIG. 1 such as a walkable power transmitter 101 such as a mat-like wireless power transmitter device 101 to be laid on the floor. The transmitter device 101 comprises a power source 102 and at least one transmitter coil 103; a wearable wireless power receiver 105, also referred to as wireless power receiver device 105 that can be affixed to the lower-limb of the user 110. The receiver device 105 comprises a receiver coil 106 and may further comprise a power conversion stage 107; an electronic device 109, in particular a wearable electronic device 109 that can be mounted around the head area of the user 110. The wearable electronic device 109 requires power to either charge its battery or to be supplied continuously in implementations of the device 109 without a battery; a power distribution medium 108, also referred hereinafter as an electric guide 108 from the wearable wireless power receiver 105 to the wearable electronic device 109.

FIG. 1 also shows a wearable wireless power receiver arrangement 105a that comprises the wearable wireless power receiver 105, the wearable electronic device 105 and/or a second wearable electronic device and the electric guide 108.

The WPT system 100 can be used to provide power to the electronic device 109 worn while being in use or that is carried by a user 110. That means that the receiver device 105 is subjected to the dynamic motion from the user 110 within a defined space. This situation may arise, for example, when the user 110 has a battery-powered extended reality headset 109 whose battery is depleting and needs to be charged but the user 110 requires to continue using the device 109. Such a scenario can arise when the user 110 is playing a virtual reality game for an extended period of time.

The wearable wireless power receiver 105 can be used for receiving an electromagnetic field 104 and transforming the electromagnetic field 104 into electric power for powering a wearable electronic device 109. The wearable wireless power receiver 105 is configured for location at a lower limb 111 of a person 110, e.g. at a foot or the ankle area of the person.

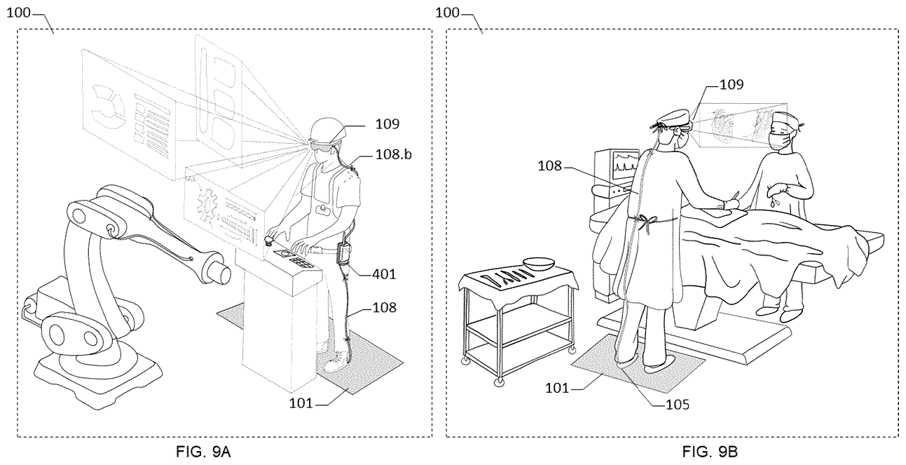

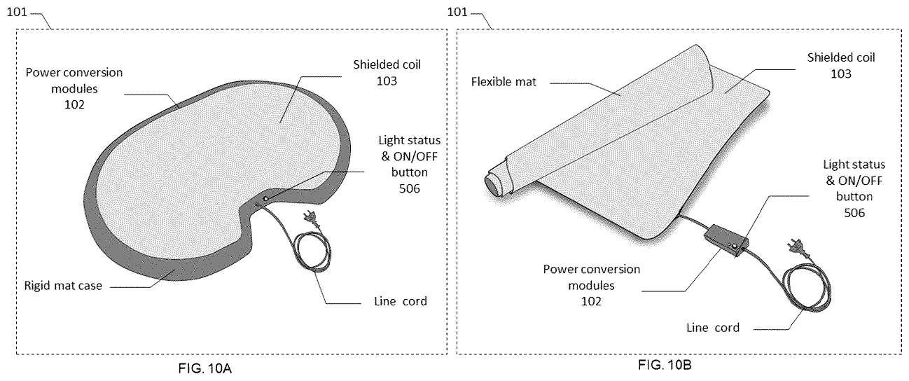

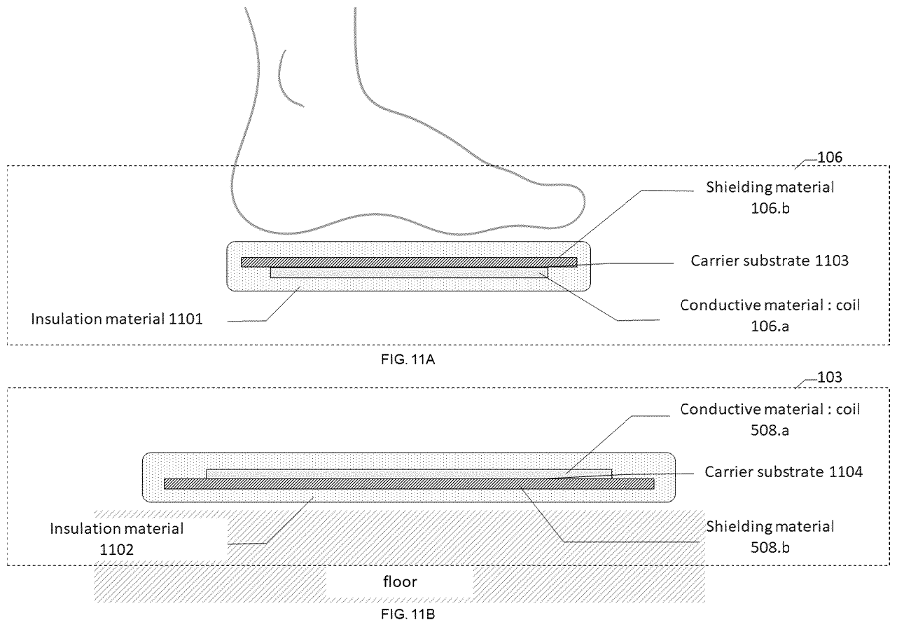

The wearable wireless power receiver 105 comprises: a carrier substrate 1103, e.g., as shown in FIG. 11A and FIG.B; an electrically conductive material 106.a, also shown in FIG. 11A, mounted at the carrier substrate 1103. The electrically conductive material 106.a is forming at least one receiver coil 106. The carrier substrate 1103 with the mounted electrically conductive material 106.a is formed to adapt to the footwear 111 of the person 110. The at least one receiver coil 106 is configured to receive an electromagnetic field 104.

In this context, the term “configured for location at a lower limb” means that the wearable wireless power receiver 105 can be attached, fixed or embedded below, around, inside or within footwear, insoles, outsoles or even clothing at the lower limb of the person for example at the feet and/or ankles area.

The wearable wireless power receiver 105 may further comprise a shielding material 106.b, also shown in FIG. 11B, mounted at the carrier substrate 1103. The shielding material 106.b is configured to shield the person 110 from at least a portion of the electromagnetic field 104.

The carrier substrate 1103 may comprise a first surface configured to face the person 110 and a second surface opposing the first surface. The shielding material 106.b may be mounted at the first surface of the carrier substrate 1103, and the electrically conductive material 106.a forming the at least one receiver coil 106 may be mounted at the second surface of the carrier substrate 1103.

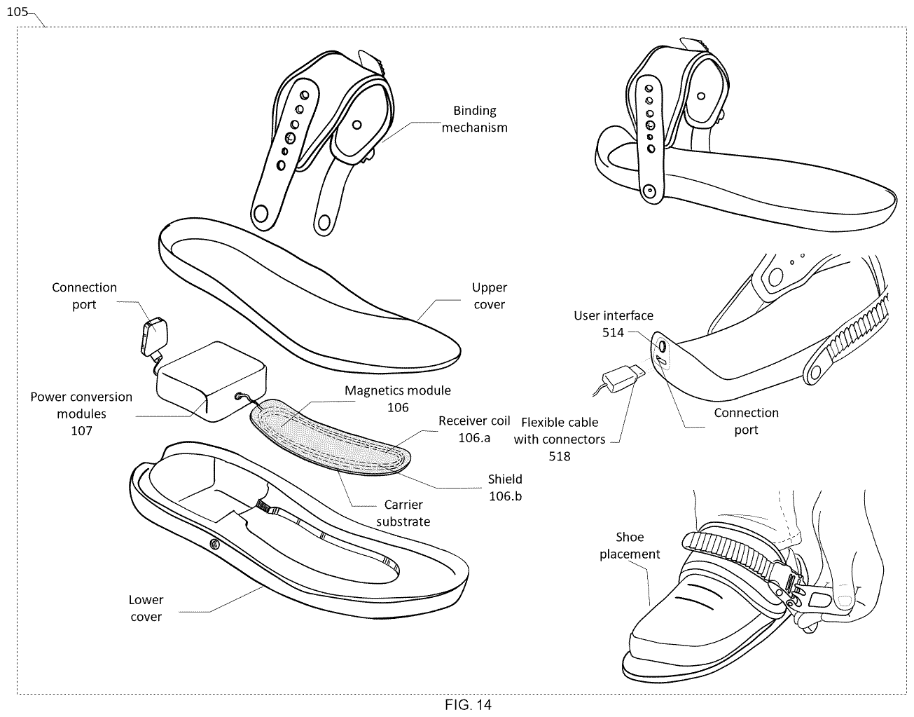

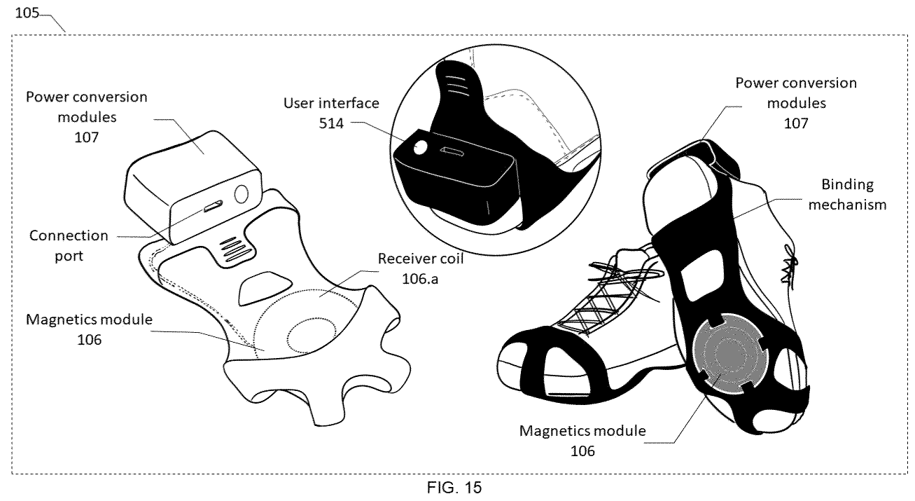

The carrier substrate 1103 with the mounted electrically conductive material 106.a and with or without the shielding material 106.b may be formed to be removably attached to a bottom part of a shoe, e.g., as shown in FIG. 14 and FIG. 15.

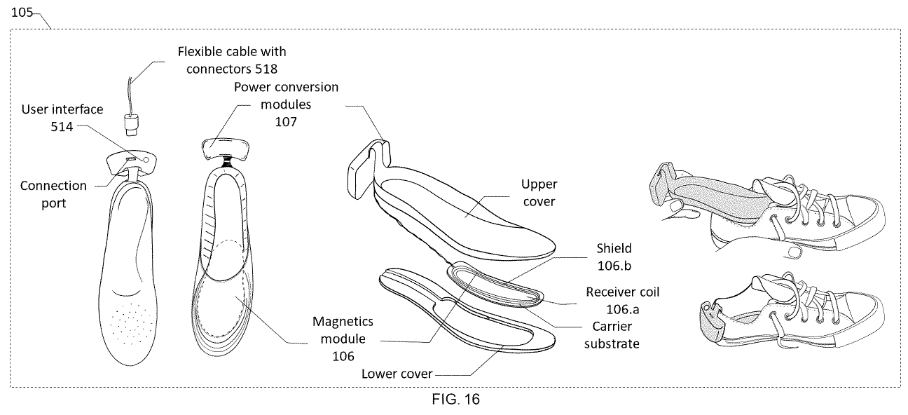

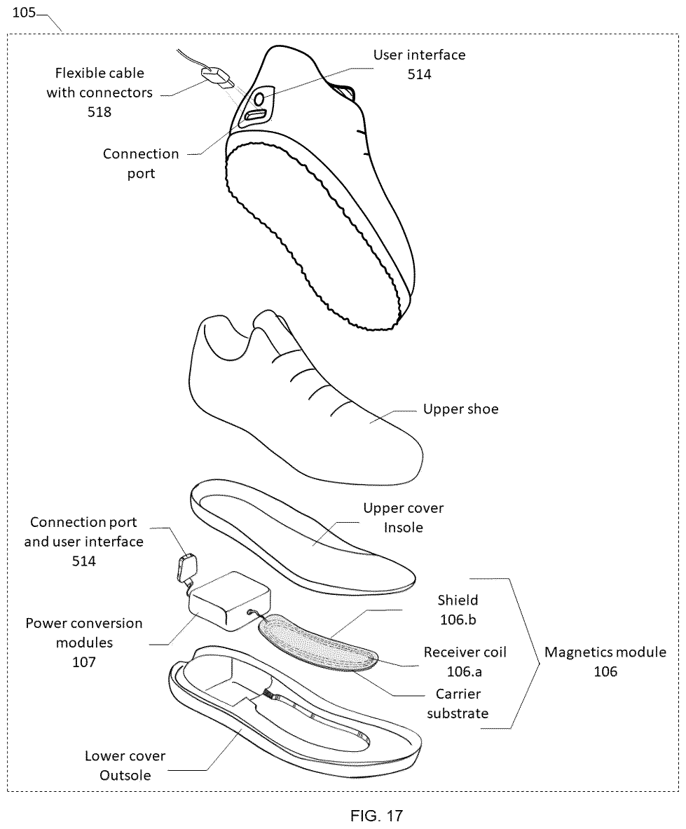

The carrier substrate 1103 with the mounted electrically conductive material 106.a and with or without the shielding material 106.b may be formed to be embedded into an insole of a shoe, e.g., as shown in FIG. 16.

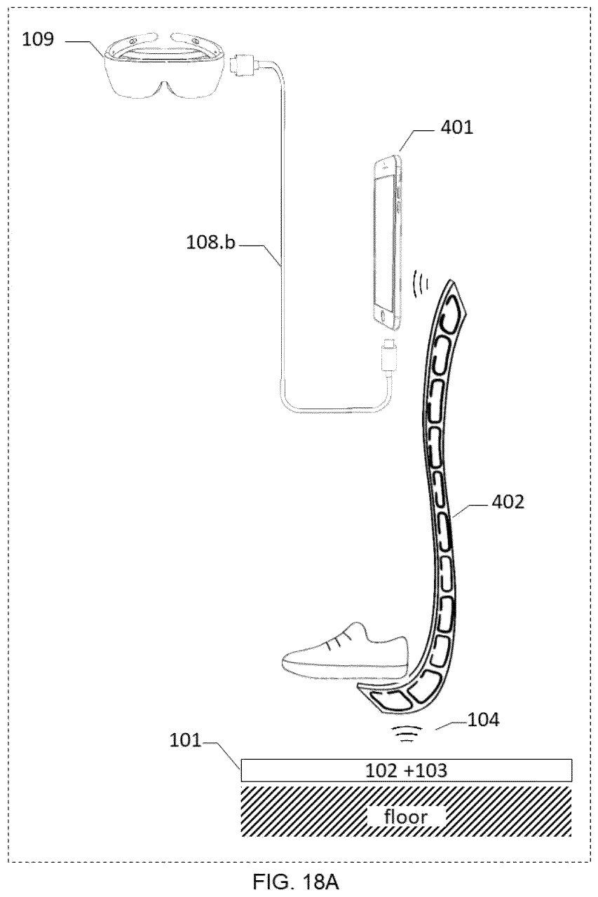

The carrier substrate 1103 with the mounted electrically conductive material 106.a and with or without the shielding material 106.b may be formed to be embedded into an outsole of a shoe, e.g., as shown in FIG. 17.

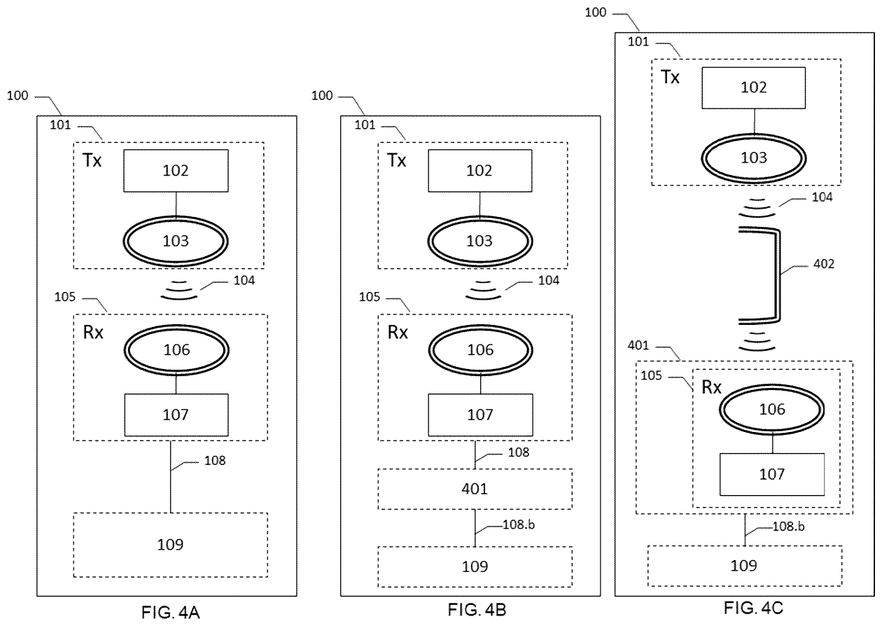

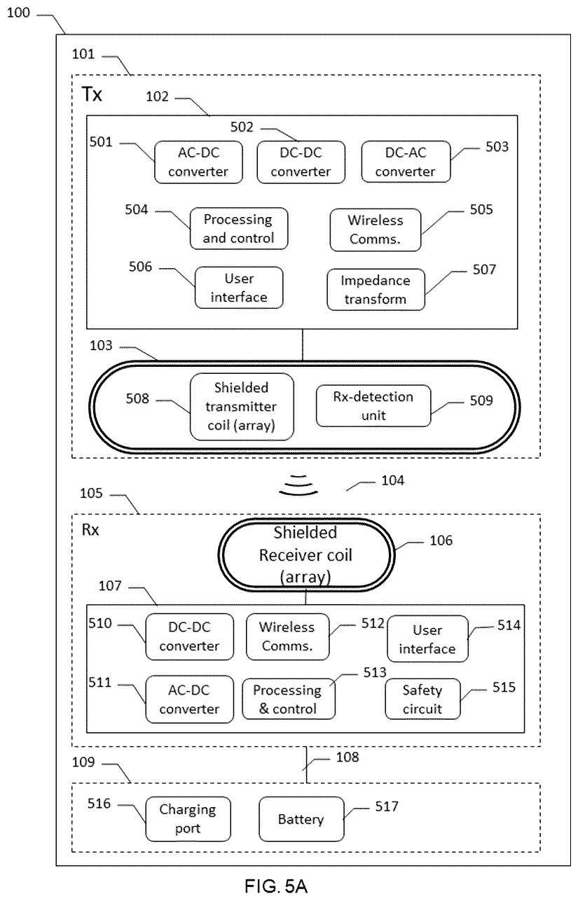

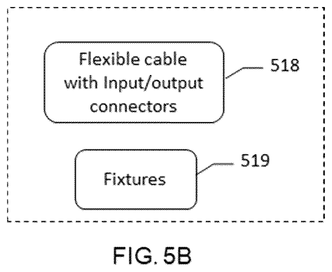

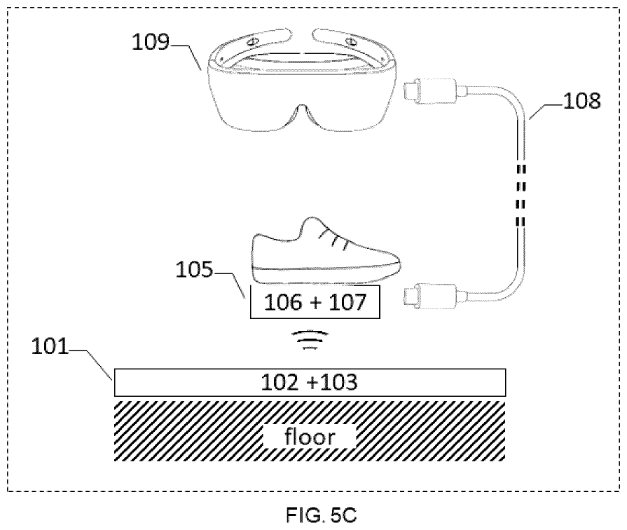

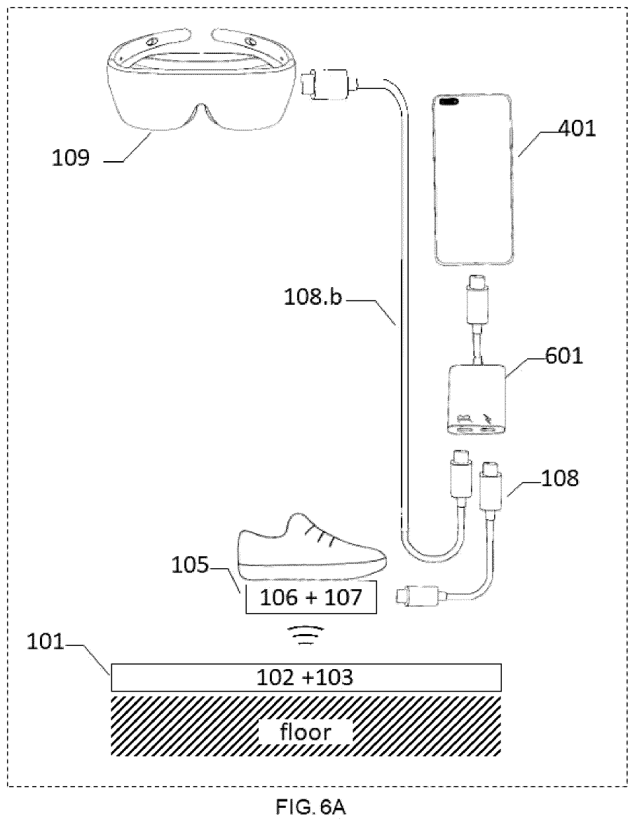

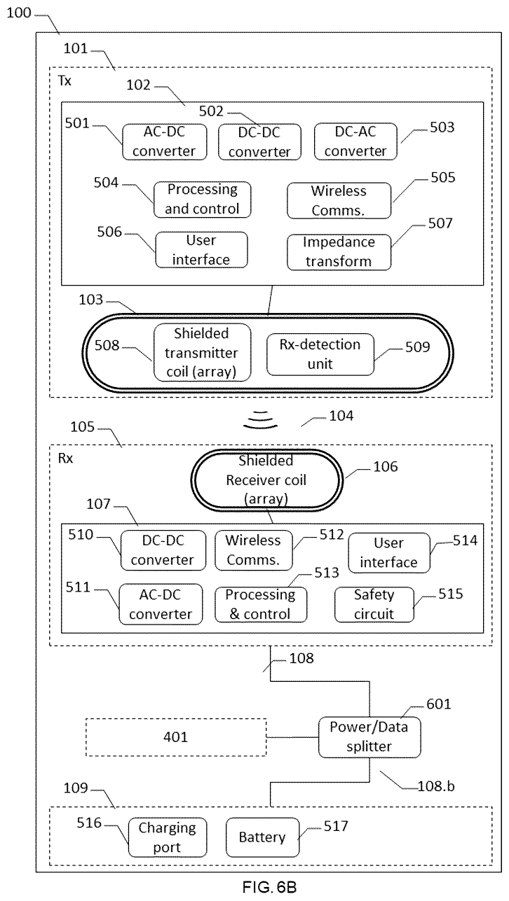

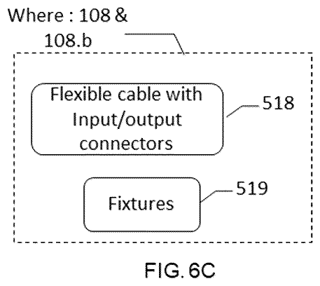

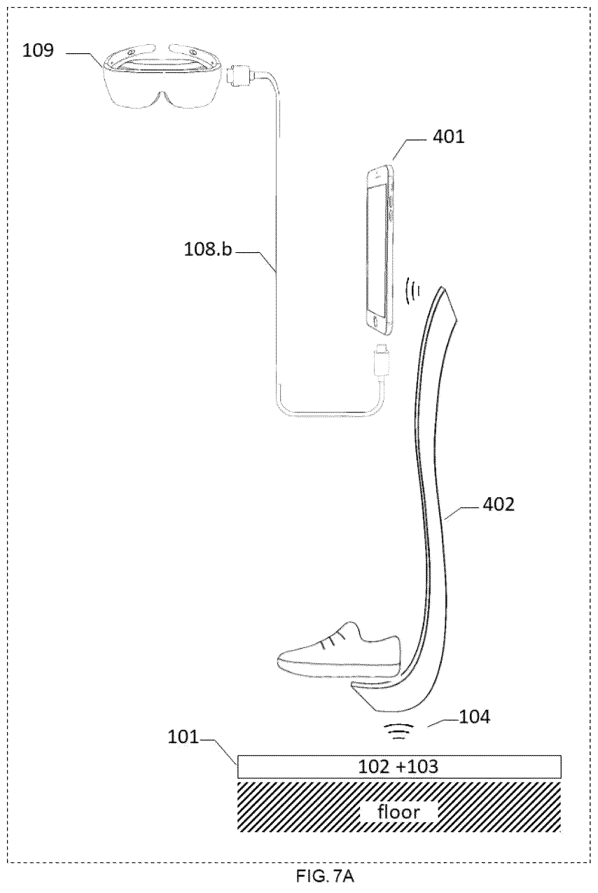

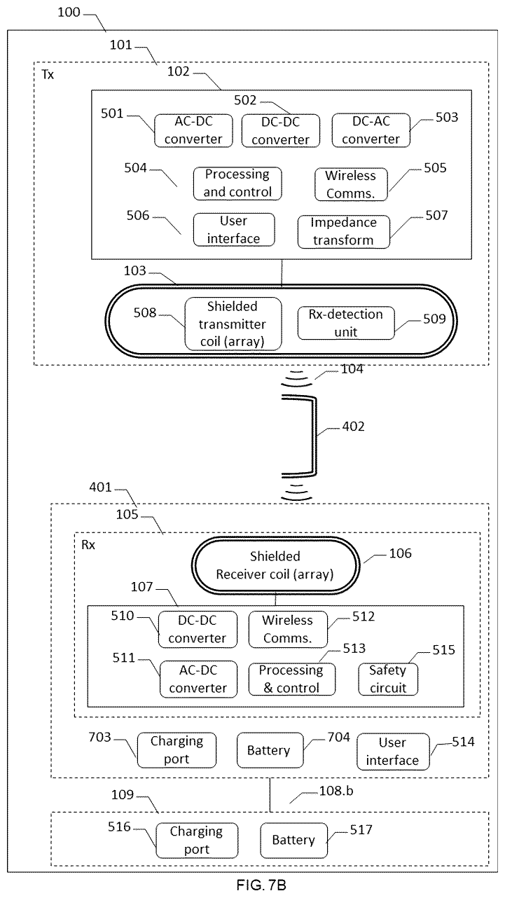

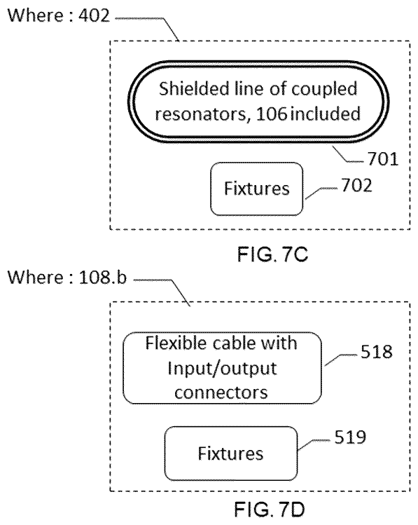

The wearable wireless power receiver 105 may further comprise: a power conversion entity 107, e.g., as shown in FIG. 4A-FIG. 4C and further exemplified in FIG. 5A, FIG. 6B, and FIG. 7B that may be configured to transform the electromagnetic field 104 received by the wireless power receiver 105 into electric power and to provide the electric power via an electric guide 108 to the wearable electronic device 109.

The wearable wireless power receiver 105 may comprise: an electrical connector 1401, e.g., as shown in FIG. 14 for connecting an electrical cable as the electric guide 108. The electrical connector 1401 may be configured to provide the electric power via the electrical cable 108 to the wearable electronic device 109.

The wearable wireless power receiver device 105 can be included about in or out of a footwear 111 for a person 110, e.g., as shown in FIG. 14 to FIG. 17.

The wearable wireless power receiver device 105 may comprise a user interface 514, e.g., as shown in FIG. 14 to FIG. 17, for displaying the status of the wireless power receiver.

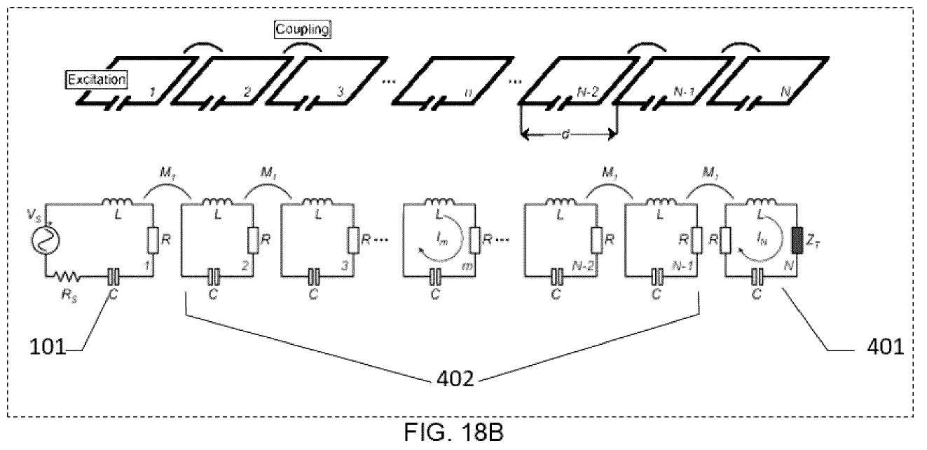

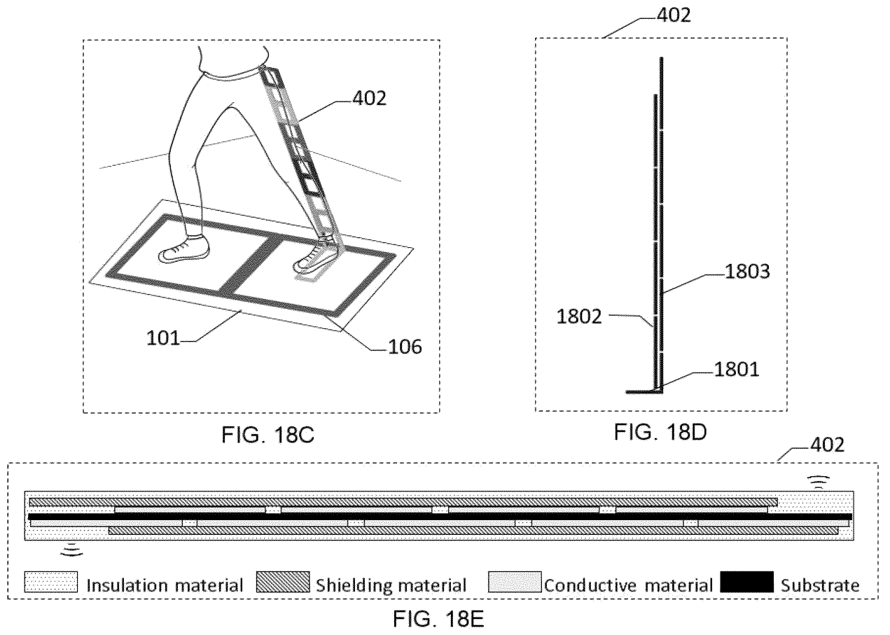

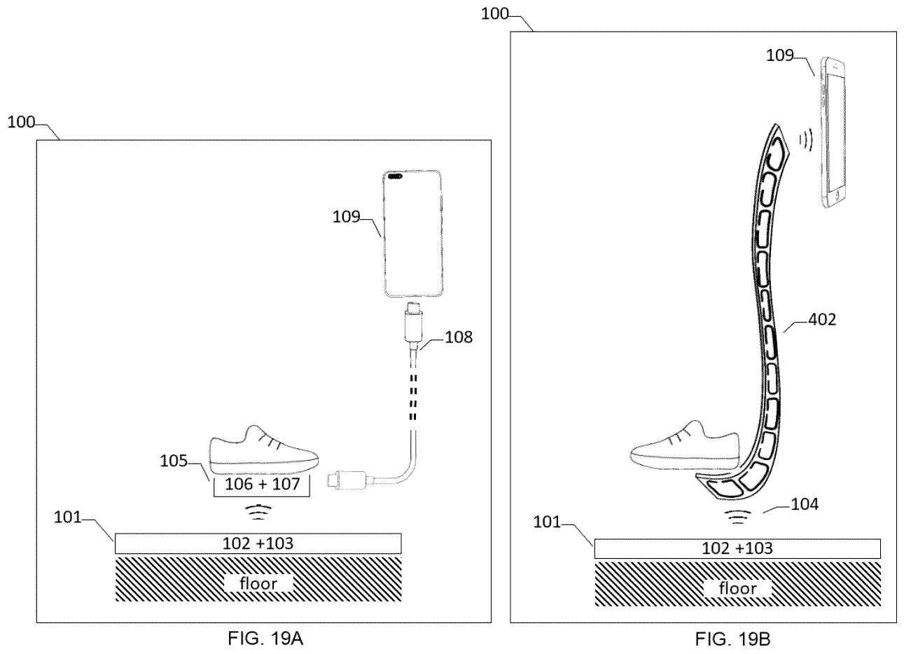

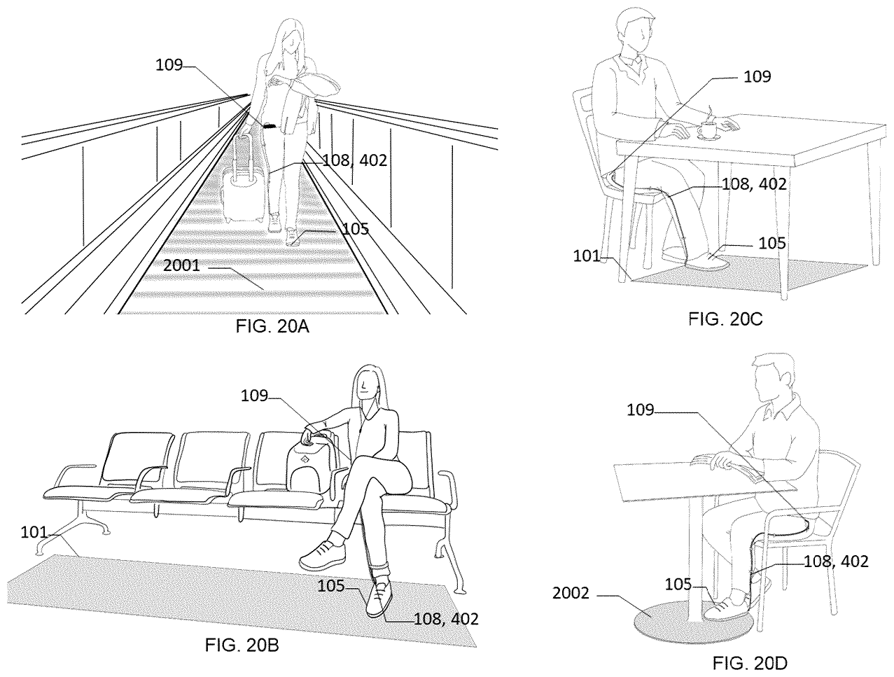

The wearable wireless power receiver device 105 can be included in a wearable coupled resonator array 402, e.g., as shown in FIG. 7A, FIG. 7B, FIG. 18A, FIG. 18B, FIG. 18C, FIG. 18D, FIG. 19B, and FIG. 20A-FIG. 20D. Such a wearable coupled resonator array 402 is configured to extend from the footwear 111 of the person 110 to a location of the wearable electronic device 109 or to a location of a second wearable electronic device 401. The wearable coupled resonator array 402 is configured to receive an electromagnetic field 104 and to relay it from the footwear 111 of the person 110 to the location of the wearable electronic device 109 or to the location of the second wearable electronic device 401.

The wearable electronic device 109 and/or the second wearable electronic device 401 may comprise a wireless power receiver entity 403 of its own, e.g., as shown in FIG. 4C or FIG. 7B that may be configured to receive the electromagnetic field 104 from the coupled resonator array 402.

The wearable wireless power receiver arrangement 105a shown in FIG. 1 can be used for powering at least one of a wearable electronic device 109 or a second wearable electronic device 401. The wearable wireless power receiver arrangement 105a comprises: a wearable wireless power receiver 105 as described above, a footwear as described above, or a wearable coupled resonator array 402 as described above, being configured for location at a lower limb of the person 110; a wearable electronic device 109 and/or a second wearable electronic device 401 configured to be powered by the wearable wireless power receiver 105; and an electric guide 108, 108.b configured to transport the electric power from at least one of the wearable wireless power receiver 105 and the second wearable electronic device 401 to at least one of the wearable electronic device 109 and the second wearable electronic device 401.

The second wearable electronic device 401 may be configured to charge itself with part of the electric power and forward the rest of the electric power received via a first electric guide 108 from the wearable wireless power receiver 105 via a second electric guide 108.b to the wearable electronic device 109, e.g., as shown in in FIG. 4B, FIG. 4C, FIG. 6A, FIG. 6B, FIG. 6C, FIG. 7A, FIG. 7A, and FIG. 7D.

The second wearable electronic device 401 may comprise a wireless power receiver entity 403, e.g., as shown in FIG. 4C or FIG. 7B that may be configured to receive the electromagnetic field 104 from a coupled resonator array 402, convert the electromagnetic field 104 into electric power, charge itself with part of the electric power, and/or forward the remaining part of the electric power via an electric guide 108.b to the wearable electronic device 109.

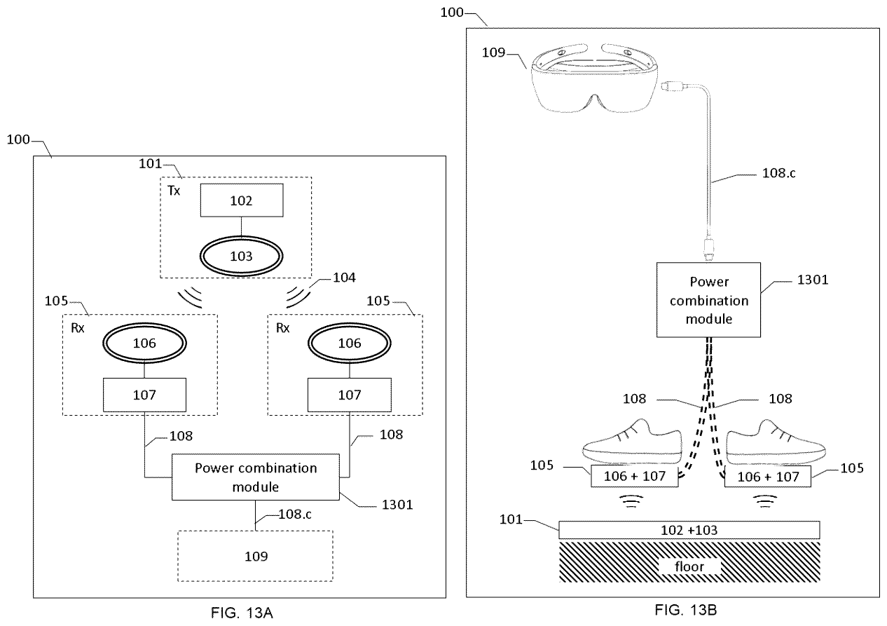

The wearable wireless power receiver arrangement 105a may comprise a second wearable wireless power receiver 105 as described above, e.g., according to the scenario shown in FIG. 13B. The second wearable wireless power receiver 105 can be attached to a second footwear of the person for powering at least one wearable electronic device 109, 401.

The wearable wireless power receiver arrangement 105a may comprise: a power combiner 1301, e.g., as shown in FIG. 13A and FIG. 13B, configured to combine the electric powers from the wearable wireless power receiver 105 and the second wearable wireless power receiver 105 for powering the wearable electronic device 109 and/or the second wearable electronic device 401 with the combined electric power of both wearable wireless power receivers 105.

The walkable power transmitter 101 shown in FIG. 1 can be used for powering at least one of a wearable electronic device 109 and a second wearable electronic device 401 through the use of a wearable wireless power receiver arrangement 105a as described above.

The walkable power transmitter 101 comprises: a power source 102; a carrier substrate 1104, e.g., as shown in FIG. 11B; an electrically conductive material 508.a, also as shown in FIG. 11B, mounted at the carrier substrate 1104. The electrically conductive material 508.a is forming at least one transmitter coil 103. The carrier substrate 1104 with the mounted electrically conductive material 508.a is formed to adapt to a floor 101a walkable by a person 110. The at least one transmitter coil 103 is configured to transmit an electromagnetic field 104 for powering at least one of a wearable electronic device 109 and a second wearable electronic device 401.

In this context, the term “walkable/walking” means that a person can walk on or over the power transmitter, the person can have his feet on the power transmitter, e.g., when sitting on a chair next to the power transmitter. The power transmitter can be below a table and the person can put his feet on the power transmitter. The term “walkable/walking” also includes the meaning of “steppable/stepping”, i.e., being able to be stepped on or over. “Walkable/walking” here means the capability of being walked on or over; real walking by the person on or over the transmitter can happen but does not have to take place.

The walkable power transmitter 101 may comprise a shielding material 508.b, e.g., as shown in FIG. 11B, mounted at the carrier substrate 1104. The shielding material 508.b may be configured to shield the floor 101a from the power transmitter 101 and vice versa.

The carrier substrate 1104 may comprise a first surface configured to face the person 110 and a second surface opposing the first surface. The shielding material 508.b may be mounted at the second surface of the carrier substrate 1104, and the electrically conductive material 508.a forming the at least one transmitter coil 103 may be mounted at the first surface of the carrier substrate 1104.

The carrier substrate 1104 with the mounted electrically conductive material 508.a may be formed to be embedded in a mat that can be laid on the floor 101a, e.g., as shown in FIG. 10B. Alternatively, the carrier substrate 1104 with the mounted electrically conductive material 508.a may be formed to be embedded into the floor 101a.

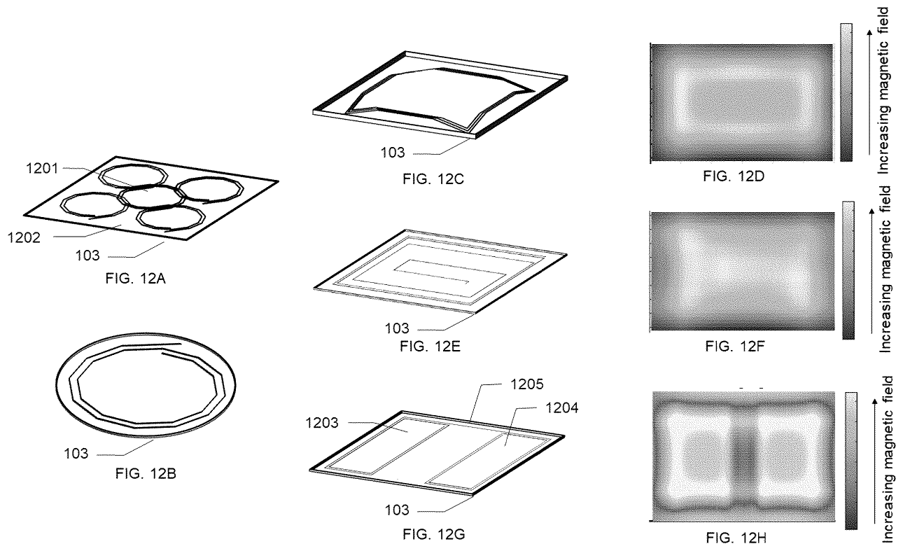

The carrier substrate 1104 with the mounted electrically conductive material 508.a may extend over a first region onto which the person can place a first foot and a second region onto which the person can place a second foot, e.g., as shown in FIG. 12A-FIG. 12H.

The walkable power transmitter 101 may comprise substrate extensions located at corners of the carrier substrate 1104, e.g., as shown in FIG. 12C, the substrate extensions being displaced in height with respect to a main plane of the carrier substrate 1104. The at least one transmitter coil 103 is formed on the carrier substrate 1104 and on the substrate extensions in order to increase uniformity of the generated electromagnetic field 104 distribution in a direction perpendicular to the main plane.

The walkable power transmitter 101 may comprise: a case for housing the carrier substrate 1104 with the mounted electrically conductive material 508.a and with or without the shielding material 508.b and the power source 102, e.g., as shown in FIG. 10A.

The walkable power transmitter 101 may comprise a flexible mat, e.g., as shown in FIG. 10B, comprising the carrier substrate 1104 with the mounted electrically conductive material 508.a and with or without the shielding material 508.b. The flexible mat can be rolled and/or folded. The power source 102 can be attached outside the flexible mat, e.g., as shown in FIG. 10B.

The at least one transmitter coil 103 may be configured to generate at least two charging hotspots, e.g., as shown in FIG. 12G, for powering at least a wearable electronic device 109, 401 and a second wearable electronic device 109, 401.

The walkable power transmitter 101 may comprise a user interface 506, e.g., as shown in FIG. 5A, FIG. 6B, FIG. 7B, FIG. 10A, and FIG. 10B, for displaying its status and/or remote controlling the walkable power transmitter 101.

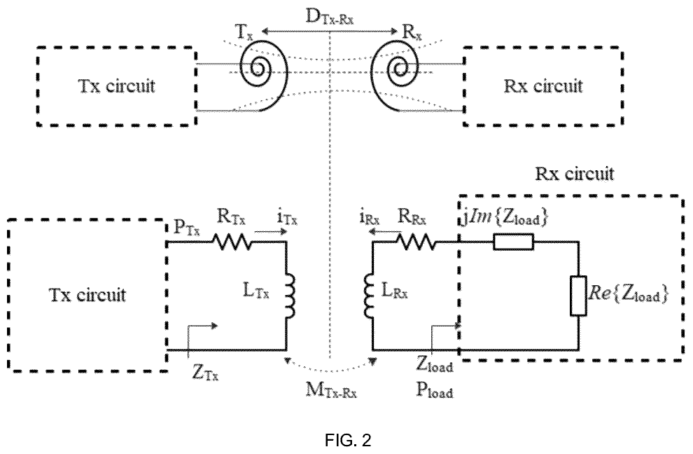

Such a WPT system 100 as described above with respect to FIG. 1, allowing the dynamic range is depicted in FIG. 2, which shows a system in which the power is transferred from the transmitter circuit to the receiver circuit by means of a magnetic resonant link. In actuality, each coil is made up of its desired characteristic, its self-inductance, as well as a few undesirable components that can be grouped into resistive and capacitive components. For the purpose of simplicity, no parasitic capacitors of the transmitter and receiver coils are considered in this model. The lumped parasitic resistances of the inductances LTx and LRx, which model the losses in their windings, are RTx and RRx, respectively. The transmitter and receiver coils, separated by an arbitrary distance DTx-RX have a mutual inductance of MTx-RX, which is determined by their geometry, relative position and orientation.

The input impedance of the Rx-circuit is denoted in this figure as Zload, which can be composed by a real part and an imaginary part. Zload can represent, for instance, a load connected directly to the receiver resonator or it may arise from a subsequent part of the power conversion chain in the receiver device, for example from a rectifier circuit and a DC-DC converter.

When considering that the wireless power transmission between the transmitter and the receiver resonators happens in the near-field of the transmitter, there are no radiation effects included. Therefore, all the losses in the system occur due to the parasitic resistances of the transmitter and the receiver coils, RTx and RRx. In this manner, the power supplied by the transmitter circuit (Tx-circuit) is delivered to the receiver circuit (Rx-circuit) affected by the coils' mutual inductance and it is dissipated as heat in the equivalent series resistances of the coils.

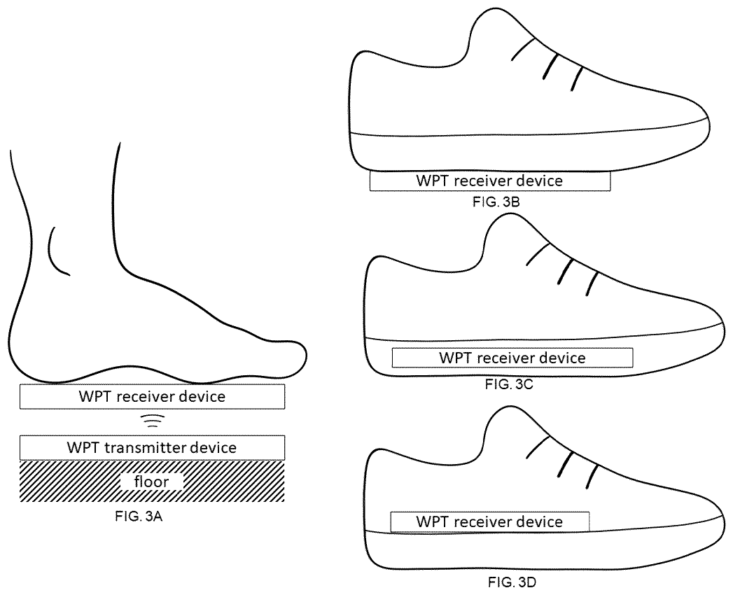

The WPT system circuit diagram of FIG. 2 can be translated into the application scenario of FIG. 1 by the usage of the components found in FIG. 3A-FIG. 3D. A mat-like wireless power transmitter device laid on the floor, shown in FIG. 3A provides wireless power to a receiver worn on the lower limb of the user. The receiver device is subjected to motion but within a defined area and in close proximity to the transmitter ensuring a large enough mutual inductance between the two resonator circuits.

The wireless power receiver device located on the lower-limb of the user can be fixed or placed on the FIG. 3B outside of the shoe, at the bottom or around it, FIG. 3C inside the shoe or FIG. 3D embedded within the shoe.

The solution presented in this disclosure is applicable to wireless power receiver devices like smartphones, wearables like smartwatches, fitness bands, extended reality headsets and hand-controllers, over-ear headphones, tablets, portable computers, smart glasses, gaming controllers, remote controls, hand-held terminals, portable gaming consoles, portable music players, used in WPT systems that the user requires to use the device while charging it.

A typical use case for the solution described herein is that an electronic device worn by the user is supplied while the user is on top of a mat-like structure. Such a scenario can include the use of a wireless power transfer system as described in this disclosure.

FIG. 4A-FIG. 4C show three WPT systems of the disclosed technology in FIG. 1. The system of FIG. 4A comprises a wireless power transmitter device 101 and at least one wireless power receiver device 105. The wireless power transmitter device comprises a power source 102, a magnetics module 103 comprising at least one transmitter coil forming a resonant circuit in conjunction with an external capacitance as exemplified in FIG. 2.

The wireless power transmitter device is operated to produce a closed electrical circuit for electrons to flow through and to generate an electromagnetic field 104 that emanates from the transmitter device; wherein the wireless power transmitter device 101 is operated to wirelessly power or charge electric or electronic device(s) 109 by providing the produced electromagnetic field by the magnetics module 103 to a receiver coil or coil array 106 into electrical energy by the use of a power conversion module 107 and provide the converted power to the electronic device 109 through a power distribution media 108.

In order to use the power coming from the transmitter device, the wireless power enabled-receiver receives the power coming from the transmitter, converts it from an AC to a DC signal using the power conversion module 107, then the power is distributed through the power distribution media 108 to the device requiring charge 109. In some other implementations, like the one depicted in FIG. 4B, the power distribution can happen twice, first using the distribution medium 108 to provide the power to an intermediate electronic device 401 such as a smartphone providing external processing power and then using a second power distribution medium 108.b to provide power to the end electronic device 109. In some other implementations, like the one depicted in FIG. 4C the power distribution can happen before the power conversion step. According to the embodiment of FIG. 4C the power distribution medium can guide the received electromagnetic field 104 through the medium 402 to the intermediate electronic device 401 which is fitted with a wireless power receiver device 403 and then further provide the received power to the end electronic device 109 through a power distribution medium 108.b.

FIG. 5A-FIG. 5C show a detailed implementation of the WPT system of FIG. 1 and further explains the modules of the system of FIG. 4A. The wireless power supply 102 comprises, the AC power source 503 of the wireless power transmitter device 101. This power source may be connected to the output of a DC-DC converter 502, in order to extract the required power for its function from a DC power source, such as a battery in the transmitter device. In some other implementations the transmitter device may also have the possibility to extract the required power for its function from an AC-DC converter 501, such as a circuit that converts the AC power of the line into a DC power. The transmitter device may also include an impedance transformation circuit 507 that is capable of transforming the output impedance of the DC-AC converter 503 from one value to another value. Such a transformation unit is useful for impedance matching in order to transfer optimum power to the receiver device. The power supply 102 being connected to a magnetics module 103 comprising at least one transmitter coil 508 and a receiver detection unit 509. As explained by FIG. 2, the combination of an inductive element 508 and a capacitance form a resonant inductive-capacitive resonator circuit capable of generating an electromagnetic field 104.

The wireless power transmitter 101 can be capable of adjusting the WPT by the use of the processing and control unit 504, for example, by operating it to change the characteristics of the AC source 503 like changes in the magnitude, phase or frequency or combinations of thereof to generate a change in the electromagnetic field 104 that emanates from the transmitter device 101 to wirelessly power and charge electric or electronic device(s) 105 and 109 or by operating the impedance transformation network 507. These possible changes can be achieved with the use of a receiver detection unit 509 that is directly affected by a possible change in the coupling conditions of the at least one receiver 105 with respect to the transmitter 101. For example, when a receiver device is moved from a previous to a new location, because of the electromagnetic coupling 104 that exists between the receiver coil or coil array 106 and the transmitter coil or coil array 508, there will be a change reflected on the transmitter coil or coil array 508 by a change in the impedance with which the receiver device 105 loads the wireless power transmitter 101. For example, in the case where the receiver 105 is composed by one single resonator with a total impedance of Z_{Rx} and that it is connected to a load R_{L} in series, the impedance “reflected” Z_{reflected} to the transmitter coil 508 is given by:

$${Z}_{reflected} = \frac{{ω}^{2} {M}_{Rx \to Tx}^{2}}{{Z}_{Rx} + {R}_{L}} \qquad ( 1 )$$

where ω is the angular operation frequency and M_{Rx→Tx} is the mutual inductance between the single receiver resonator and a given transmitter resonator. The receiver detection unit can be implemented by a bi-directional coupler connected as a reflectometer and that in turn is connected to an RF detector circuit. The power detection unit may be comprised by other voltage/current/impedance/power sensitive circuit that will be directly affected by (1) for a changing coupling condition of the receiver(s). Note that even when the receiver device 105 did not undergo a change in position or orientation, (1) can still be affected when a change in the load of the receiver device, that is, the electronic device 109, occurred.

The processing and control unit 504 can also be affected by the information coming from a possible wireless communication unit 505 in the transmitter device 101 which is capable to wirelessly communicate to the wireless communication unit 512 in the receiver device 105 through electromagnetic waves. The two wireless communication units may exchange information via two distinct transducers compatible with, but not limited to BLUETOOTH, Bluetooth Low Energy (BLE), ZIGBEE, WIFI, wireless local area network (WLAN), Thread, cellular communications like second generation (2G)/third generation (3G)/fourth generation (4G)/fifth generation (5G)/Long-Term Evolution (LTE), narrowband internet of things (NB-IoT), near-field communication (NFC), radio frequency identification (RFID), WIRELESSHART, among others. On the receiver device 105, the wireless communication unit 512 may aid in controlling the power conversion modules 511 and 510 via its own data processing and control unit 513 that may be present in the receiver device 105. There can be a script running inside 513 capable of gathering the relevant information related to the coupling conditions of the receiver(s) and other information like the level of the charge of the battery 517 in the electronic device 109 connected to the receiver device 105 by means of the power distribution medium 108.

The receiver device 105 can have a single coil or an arrangement of coils 106 acting as the inductive element(s) of an inductive-capacitive resonator(s). In some implementations, the receiver device 105 may be connected to an AC-DC converter 511, for example a rectifier that converts the alternating current (AC) to a direct current (DC) if the device to be powered by the specific application requires DC, such as the case of delivering DC power to an electronic device. In some other implementations, there can be a circuit 510 to convert a DC power level to another DC power level, such as a DC-DC converter or a charging circuit used to regulate the power delivered to the electronic device 109. The receiver device further comprises a safety circuit 515 capable of avoiding a fault operating mode by interrupting the power delivery to the device 109.

Both the transmitter and receiver device can include a user interface, 506 and 514 to help the user of the devices know that the power transfer is commencing or taking place as well as any other possible fault operating state.

The power distribution medium 108 is further explained in FIG. 5B. The distribution media may include a flexible insulating material fitted with an electrical conductor as well as input and output connectors 518 and some fixture structures 519 that allow to fix the distribution medium to the user in order to ensure a comfortable and safe connection between the receiver device 105 on the lower limb of the user and the head-mounted electronic device 109 requiring power. FIG. 5C shows a possible implementation of the system disclosed in FIG. 5A and FIG. 5B for the power delivery to a head-mounted device 109 with the use of the wireless power transmitter 101, the receiver 105 and the distribution medium 108.

FIG. 6A-FIG. 6C show another detailed possible implementation of the disclosed technology and further explains the modules of the system of FIG. 4B. FIG. 6A depicts how wireless power being generated by the transmitter device 101 is received by the receiver device 105 where it is converted into electrical energy to provide power to two devices, the intermediate device 401 through the power distribution medium 108 and to the end device 109 through the power distribution medium 108.b by employing a splitter element 601. FIG. 6B further clarifies the power flow from the transmitter to the receiver and the two electronic devices, 401 and 109. In such an implementation, there are two power distribution media, 108 and 108.b and a data/power splitter 601. FIG. 6C shows the power distribution media. The implementation in FIG. 6A-FIG. 6 is useful to provide the generated power by the transmitter device to devices that are not fitted with an enabled wireless power receiver device.

FIG. 7A-FIG. 7D show further implementation of the disclosed technology, explaining in detail the modules of the system of FIG. 4B. FIG. 7A depicts how the wireless power generated by the transmitter device 101 is guided through an array of coupled resonators 402 capable of guiding the electromagnetic field 104 generated by the transmitter device 101 to further increase its transmission range to the intermediate device 401. In this case, as further clarified by FIG. 7B, the intermediate device 401 is already fitted with a wireless power receiver device 403 capable of converting the received electromagnetic field into electrical energy suitable to charge the battery 704 on the intermediate device 401 as well as to deliver electrical power to the end electronic device 109 through the power delivery medium 108.b with purpose of charging the battery 517 by performing an electrical connection of the flexible cable 518 between the intermediate device 401 and the charging port 516 on the end device. FIG. 7C shows the power distribution medium 402 and FIG. 7D shows the power distribution medium 108.b. Note that the difference between the distribution medium is that 402 uses an array of coupled resonators guiding the energy electromagnetically, while 108.b guides the energy through an electrical connection.

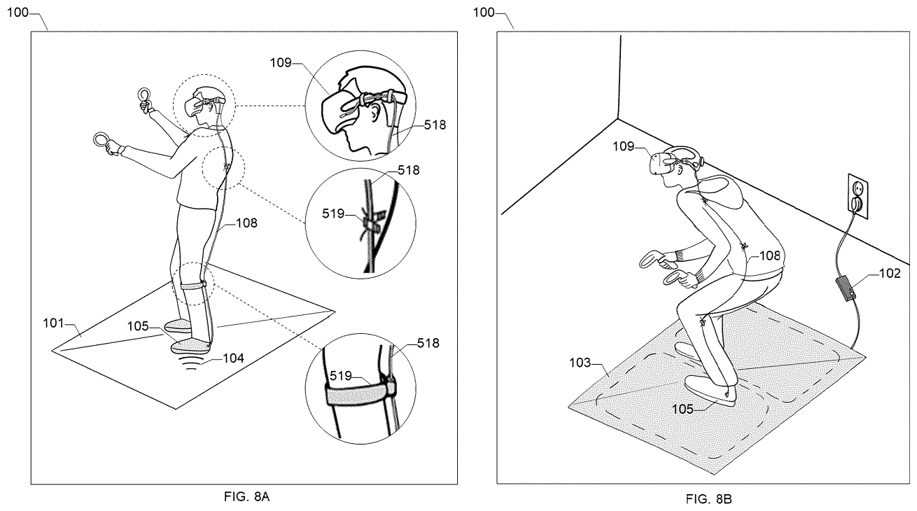

The implementations disclosed in FIG. 5A-FIG. 7D can be used, for example, in the case where a user is playing a virtual reality game as exemplified in FIG. 8A and FIG. 8B. FIG. 8A shows a possible embodiment of the transmitter, receiver, and power delivery medium in order to provide continuous power to the end device, in this case a virtual reality headset 109. FIG. 8B illustrates some of the advantages of the disclosed technology. In this case, the user can move freely inside the defined area of the mat and maintain the battery of the end device 109 constantly charged provided that the user stays nearby the transmission range of the transmitter device. This will allow the user to be able to play continuously.

The disclosed technology can also make possible to use a battery of a smaller size thus reducing the overall weight of the end device, same that will translate into more comfort for the user. Note that provided that there is an energy storage element on the end device 109, for example a super capacitor, a battery will not be necessary altogether. In this case, the energy storage element will have to be able to provide to the electronic modules inside 109 long enough if the user were to momentary step out of the transmitter device.

Note as well that while FIG. 8A employs a transmitter device 101 with the power source 102 and magnetics module 103 integrated as a single element, FIG. 8B employs a transmitter device 101 whose power source 102 and magnetics module 103 have been separated.

The implementations disclosed in FIG. 5A-FIG. 7D can be used, for example, to assist the user to perform a certain task with the use of an extended reality headset. FIG. 9A exemplifies the implementation disclosed in FIG. 6A-FIG. 6C, where the wireless power transmitter device 101 can supply to an intermediate device 401 and to the end device 109. Both situations depicted in FIG. 9A and FIG. 9B demonstrate the usefulness of the WPT system disclosed herein. Continuous WPT can be provided in situations in which the users require certain freedom of motion within a defined area for an extended period of time.

FIG. 10A and FIG. 10B show two possible implementations of the disclosed transmitter device. The implementation in FIG. 10A depicts the wireless power transmitter device 101 containing all modules, 102 and 103 inside a rigid shell with the necessary mechanical stability for the user to safely step on. FIG. 10B shows a wireless power transmitter system 101 with separate power conversion modules 102 and magnetics module 103. This implementation has the advantage of being easily transportable from one location to another.

FIG. 11A and FIG. 11B demonstrate possible implementations of the shielded magnetic components on the transmitter and the receiver side. FIG. 11A depicts the magnetics module 106 in the receiver device 105 in detail, the module comprises an outer insulation material 1101, a shield material or a combination of materials 106.b, for example an assembly of a conductive material on the bottom and a magnetic shielding material on the top, thus shielding most of the received electromagnetic field by the receiver coil 106.a from the lower limb of the user. In some implementations the receiver and transmitter coil can be mounted on a carrier substrate 1103 and 1004, respectively. Similarly, FIG. 11B demonstrates that by the use of a shielding material or a combination of materials 508.b the floor is mostly shielded from the electromagnetic field generated by the transmitter coil 508.a and vice versa. Furthermore, 1102 show an outer insulation material used to enclose the magnetics module on the transmitter device.

FIG. 12A-FIG. 12H depict some possible implementations of the inductive element of the transmitter device 101. FIG. 12A shows the possibility of having an array of coils inside the magnetics module 103 on the transmitter 101., for example, the central coil 1201 can be connected to the power supply 102 and the outer coils 1202, enclosing 1201, can be a certain number of relay resonators effectively extending the transmission range of the excited coil 1201. This implementation has the advantage of requiring a single power source 102. FIG. 12B shows on the other hand, an implementation with a single transmitter coil connect to the power supply 102 covering a larger area, comparable to the area covered by the excited coil and relay resonators in FIG. 12A.

FIG. 12C-FIG. 12H exemplifies that depending on the geometry of the inductive element of the resonator inside the transmitter device 101, a different magnetic field characteristic can be expected. For example, FIG. 12C shows a substantially flat 3-dimensional transmitter coil having a main plane and a certain number of turns. This image shows a square coil but the coil geometry can be different. Due to the geometry of the coil, each turn has four vertices. The principal characteristic of this coil is that at least the four vertices composing a single turn are displaced with a certain negative height relative to the main coil plain. This image shows how all the vertices of each turn are displaced. Displacing the vertices of the turns of this coil has left some of the sections of the turns at the same height as the main plane. Displacing the vertices of the coil decrease the mutual inductance in critical zones when the receiver is located directly on top of the transmitter device's shell. Decreasing these maximum peaks of mutual inductance reduce the variations of the induced voltage in the receiver, as well as the maximum component stresses in the receiver avoiding possible damage of the receiver while allowing the transmitter to work with a constant current level, a necessary feature in one-to-one or one-to-many WPT systems. The resulting magnetic field characteristic of the transmitter coil FIG. 12C can be observed in FIG. 12D.

FIG. 12E shows a possible implementation of a transmitter coil inside the magnetics module 103 having a differing winding characteristic in such a way that the spacing between the turns of the coil varies. Such an implementation allows to create a more uniform characteristic of the magnetic field, as depicted in FIG. 12F. FIG. 12F shows a coil with two winding sections 1203 and 1204 of the transmitter coil inside the magnetics module 103. The sections are joined by a segment 1205 in such a way that the current through the sections has a given current direction. In the case of the coil in FIG. 12G, the current through both sections is flowing in the same direction. In other implementations, the current can flow in a different direction. Having two winding sections allow to create two sections of the magnetic field, as depicted in the characteristic in the magnetic field depicted in FIG. 12H. This implementation has the advantage of creating two charging hotspots, onto which, the user can place each foot as further explained in FIG. 13A-FIG. 13B or two users can place at least one foot enabled with a wireless power receiver 105

FIG. 13A and FIG. 13B show how a one-to-many WPT system can be used to supply to the end-device 109. In this case. the electromagnetic field 104 generated by the transmitter device 101 is received by two independent receiver devices, each one on a foot of the user. FIG. 13A shows a diagram of how the received power by each receiver device can be combined by employing a power combination module 1301 between the receiver devices and the end-device. The power combination module is combining the electrical power delivered by the receiver devices in order to provide to the end-device 109 with more power. FIG. 13B shows a possible implementation of the system disclosed in FIG. 13A for the power delivery to a head-mounted device 109 with the use of the wireless power transmitter 101, two receiver devices 105, two distribution media 108, the power combination module 1301, and a further distribution medium 108.c. Such an implementation increases the power delivery to 109.

FIG. 14 to FIG. 16 show several possible implementations of the receiver devices located on the lower limb, in particular on the shoe of the user. By placing the receiver device 105 on the shoe area, a good electromagnetic coupling to the transmitter device can be ensured, as well as a continuous power delivery to the end-device 109.

FIG. 14 shows how the power receiver device can be located on the bottom part of the shoe allowing the user to use this receiver device with any available shoe. Note that, according to the device disclosed in FIG. 13A and FIG. 13B, there can be one or two receiver devices on each one of the two shoes of the user. The power receiver device can be attached to the user using a binding mechanism.

FIG. 15 shows another possible implementation of the receiver device 105. Such a device is also located under at least one shoe of the user and attached to the user's shoe using another binding mechanism. This implementation also shares the advantage of letting the user use the receiver device with his already available shoe(s).

As depicted by FIG. 16, the wireless power receiver device can also be fitted inside the user's shoe. In this case, the receiver device is embedded into an insole. Such an implementation allows the receiver device to still be well-coupled to the transmitter device 101. The power conversion module can be located outside of the user's shoe for more comfort. This implementation has the advantage of letting the user use the receiver device with his already available shoe(s).

FIG. 17 shows a shoe with an embedded receiver device. Although this implementation requires the user to have a designated shoe fitted with a receiver device, it presents the advantage of increased comfort and ease of use as well as potentially adding more battery-powered capabilities within the same shoe.

FIG. 18A, FIG. 18B, FIG. 18C, FIG. 18D, and FIG. 18E show a possible implementation of a WPT system that uses an electromagnetic power distribution medium 402 to deliver wireless power to the intermediate electronic device 401 that has a compatible wireless power receiver 403. FIG. 18A depicts how the wireless power generated by the transmitter device 101 is guided through an array of coupled resonators 402 capable of guiding the electromagnetic field 104 generated by the transmitter 101 to further increase the transmission range of the transmitter device 101 to the intermediate device 401. In this case, the intermediate device 401 is already fitted with a wireless power receiver device 403 capable of converting the received electromagnetic field into electrical energy suitable to charge the battery on the intermediate device 401 as well as to deliver electrical power to the end electronic device 109 through the power delivery medium 108.b with purpose of charging its battery by performing an electrical connection.

FIG. 18B depicts a circuit diagram and the working principle of the power distribution medium 402. 402 is a medium capable of guiding the electromagnetic field generated by the transmitter. The medium can be composed by a given number of cells, the picture shows N cells for generality. Each of the cells of this electrical diagram is an inductive-capacitive resonator that is electromagnetically coupled to at least each nearest neighbor. This coupling is represented by the mutual inductance M1, which in this figure is considered to be mostly magnetic, due to the magnetic field generated by one cell that threads the neighboring cell and induces a circulating current in this cell. Each cell is represented by a series connection of an inductance L with its associated resistance R and connected in series with an external capacitance C. The figure denotes that the capacitance is implemented by an added lump element but in some other implementations, the self-capacitance of the coil can also be used. Each one of the cells of the diagram is forming a series resonator circuit with a given resonant frequency.

The first cell in the circuit diagram of FIG. 18B is the resonator circuit inside the transmitter device 101. Note that due to the electromagnetic coupling that exists between the transmitter device 101 and its nearest neighbor, i.e., the first cell of the coupled resonator array 402, which in this case is the wireless power receiver 105, the power can be guided from the transmitter all the way to the device 401. The last cell of the circuit diagram of FIG. 18B is the resonator circuit inside the receiver device 401, i.e. the wireless power receiver 403. The load resistance ZT in this circuit diagram represents the battery of the wearable electronic device 401 and/or 109. The amount of energy being lost along the way will depend on the quality factor of the cells as well as the mutual inductance between them.

FIG. 18C shows how the power distribution medium is thought to interact with the transmitter 101 and the user. The power distribution medium can be implemented on a semi-rigid or a flexible substrate. In fact, a flexible substrate would have the advantage of being compliable and being easier to be attached to the user wearing it. Note that in this figure a transmitter coil 106 able to produce two charging spots, like demonstrated in FIG. 12G and FIG. 12H has been employed but any other coil geometry like the ones presented in FIG. 12A-12H-can also be used.

The second cell of FIG. 18B, i.e., the wireless power receiver 105 also shown in FIG. 18D, is located underneath the user's shoe and it has a bending angle of approximately 90 degrees 1801, i.e., approximately 50% of the cell's surface is located under the shoe and the remaining surface is located substantially parallel to the user's lower leg. The consecutive cell, i.e., cell number three in FIG. 18B or 1802 in FIG. 18D has approximately 50% of overlapping with 1801 and its consecutive cell 1803. The same can be said for the remaining cells shown in FIG. 18D, thus the cells are forming something that resembles a brick-wall configuration. This configuration has the advantage of having a good mutual inductance between neighboring cells. Note that in FIG. 18B, all cells pairs have the same mutual inductance but this value can be different. Also, there can be a second order mutual inductance, i.e., between non-consecutive cells, or a third-order mutual inductance.

FIG. 18E shows a possible and detailed implementation of the wireless power distribution medium 402. From top to bottom, the medium can be enclosed by an electrically insulating material, the upper layers of cells can be on the upper layer a printed circuit board and it can be separated by a flexible substrate from the lower layer of cells. The cells' arrangement is mostly shielded by a shielding material or a combination of materials such as a stack of an electrically conductive material and a magnetically conductive material. Unshielded areas at the end and the beginning of the medium are necessary in order for it to be coupled to the transmitter and the intermediate receiver. Note that under the bottom cells, a similar shielding arrangement can be implemented. Possible variations of this arrangement can include more carrier substrates, for example at the top of the top cells and at the bottom of the bottom cells. This can be implemented by two individual printed circuit boards sandwiched together with a suitable electrically insulating interface between them. In some other implementations the magnetic shield can be removed as the energy from one cell to the next is capable of being transferred due to their mutual inductance, same that can be increased by employing the magnetic material.

The devices disclosed in the present disclosure can also be used to provide wireless power to the intermediate devices as exemplified in FIG. 19A and FIG. 19B. The situation exposed by FIG. 19A can arise if the user decides to momentary remove the head-mounted device but still provide wireless power to the intermediate device. In such a case the intermediate device 401 of FIG. 6 will become the end-device 109 in FIG. 19A. A similar situation can arise when the user of the device in FIG. 7A and FIG. 7B requires to remove the end-device 109 as depicted in FIG. 19B. In such a case, the device, 401 of FIG. 7A and FIG. 7B will become the end-device 109 in FIG. 19B. In these situations, the disclosed technology can also be employed without the need of having a head-mounted device, i.e., with the purpose of providing wireless power to the intermediate devices.

FIG. 20A, FIG. 20B, FIG. 20C, and FIG. 20D exemplify further the situations in which the systems in FIG. 19A and FIG. 19B can arise. FIG. 19A shows the user wearing a receiver device 105 being able to charge the battery of the end-device 109 by using one of the power distribution media 108 or 402 that includes a wireless power receiver 105 as explained in FIG. 19A and FIG. 19B, in this case a transmitter device or several transmitter devices can be embedded in a conveyor belt 2001. In other semi-dynamic situations like the ones expressed in FIG. 20B and FIG. 20C, the transmitter device 101 can be placed on the floor of areas in which users are expected to spend some time like waiting room/areas FIG. 20 or restaurants FIG. 20C. The situation depicted in FIG. 20D demonstrates that the transmitter device 101 can also be embedded inside the bottom part of a table, for example.

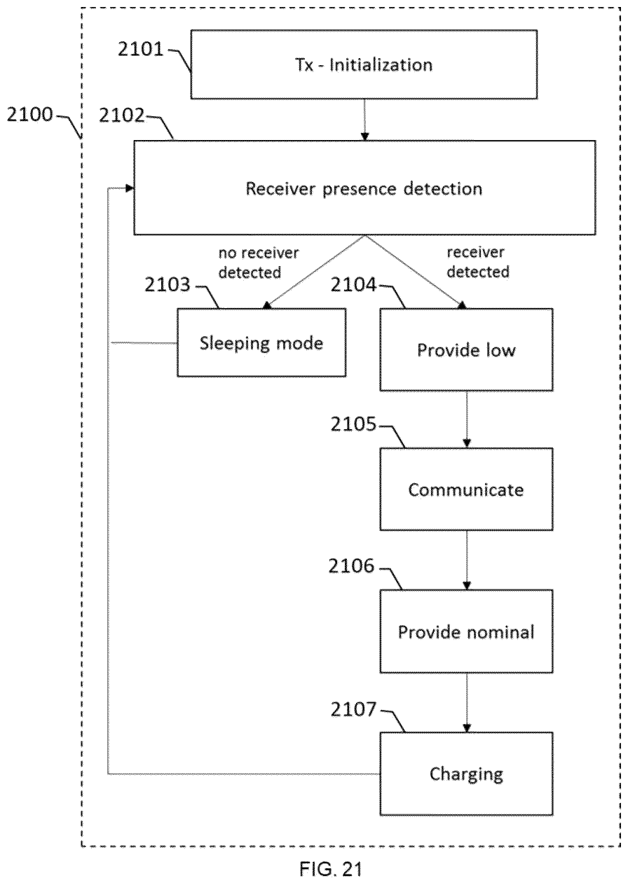

The disclosure also discloses a method 2100 to charge the battery of an extended reality headset under the dynamic movement of the user. The method 2100 is depicted in FIG. 21 and can be summarized as:

Initialization 2101: user action enables (turns ON) mat-like WPT transmitter device

Receiver presence detection 2102: detect presence of one or more compatible lower-limb-mounted wireless power receiver devices within the charging region

If no receiver is detected:

Sleeping mode 2103: Tx goes into sleeping mode and keep looping until it detects an Rx.

If Rx is detected:

Provide low power 2104: Tx provides and Rx receives wireless power at low power to be able to start communication and pairing protocol.

Communicate 2105: communication between Tx and Rx is stablished to determine compatibility. User interfaces 506 and 514 are operated to display pairing mode is in place

Provide nominal power 2106: Tx provides and Rx receives wireless power at nominal power levels

Charging 2107: Rx enables power output to supply/charge device 109. User interfaces 506 and 514 are operated to display charging mode is in place.

The method 2100 depicted in FIG. 21 can be used for powering a wearable electronic device 109 as described in this disclosure. In other words, the method 2100 comprises: enabling 2101 a walkable power transmitter 101 as described in this disclosure; detecting 2102, by the walkable power transmitter 101, one or more wearable wireless power receivers 105 as described in this disclosure; upon detecting a wearable wireless power receiver 105, providing 2104, by the walkable power transmitter 101, an initial power to the wearable wireless power receiver 105 for communicating 2105 a pairing mode between the walkable power transmitter 101 and the wearable wireless power receiver 105; and providing 2106, by the walkable power transmitter 101, a nominal power to the wearable wireless power receiver 105 for powering 2107 at least one of a wearable electronic device 109 and a second wearable electronic device 401.

The solutions presented in this disclosure are applicable to wireless power receiver devices like smartphones, wearables like smartwatches, fitness bands, virtual reality headsets and hand-controllers, over-ear headphones, tablets, portable computers, smart glasses, gaming controllers, desktop accessories like a mouse or keyboard, battery banks, remote controls, hand-held terminals, e-mobility devices, portable gaming consoles, portable music players, key fobs, drones used in WPT systems that allow a high-degree of freedom of the receiver.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although aspects have been illustrated and described herein, it will be appreciated by those of ordinary skill in the art that a variety of alternate and/or equivalent implementations may be substituted for the aspects shown and described without departing from the scope of the disclosure. This application is intended to cover any adaptations or variations of the aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is to be understood that within the scope of the appended claims and their equivalents, the disclosure may be practiced otherwise than as specifically described herein.

1. A wearable wireless power receiver comprising:
a carrier substrate configured to adapt to footwear of a person;
an electrically conductive material mounted on the carrier substrate and that is away from a lower limb of the person and forming at least one receiver coil, and wherein the at least one receiver coil is configured to receive an electromagnetic field; and
a shielding material mounted on the carrier substrate that is nearer to the lower limb of the person and configured to shield the person from at least a portion of the electromagnetic field.

2. (canceled)

3. The wearable wireless power receiver of claim 1, wherein
the carrier substrate is further configured to be embedded into an outsole of the footwear.

4. The wearable wireless power receiver (105) of claim 1, wherein the carrier substrate is further configured to be removably attached to a bottom part of the footwear.

5. The wearable wireless power receiver of claim 1, wherein the carrier substrate is further configured to be embedded into an insole of the footwear.

6. The wearable wireless power receiver of claim 1, wherein the wearable wireless power receiver is configured to be inserted into the footwear.

7. (canceled)

8. A wearable wireless power receiver system comprising:
a wearable wireless power receiver (105), footwear, or a wearable coupled resonator array configured for location at a lower limb of a person;
a first wearable electronic apparatus or a second wearable electronic apparatus configured to be powered by the wearable wireless power receiver; and
at least one electric guide configured to transport the electric power from the wearable wireless power receiver or the second wearable electronic apparatus to the first wearable electronic apparatus.

9. The wearable wireless power receiver system of claim 8, wherein the at least one electric guide comprises a first electric guide and a second electric guide coupled to the at least one wearable electronic apparatus, wherein the at least one wearable electronic apparatus comprises a first wearable electronic apparatus and a second wearable electronic apparatus, wherein the second wearable electronic apparatus is configured to:
receive the electric power from the wearable wireless power receiver via the first electric guide; and
charge itself with a first part of the electric power; and
forward a remaining part of the electric power to the first wearable electronic apparatus via the second electric guide.

10. The wearable wireless power receiver system of claim 8, further comprising a wearable coupled resonator array, wherein the second wearable electronic apparatus comprises a wireless power receiver entity configured to:
receive an electromagnetic field (104) from the wearable coupled resonator array;
convert the electromagnetic field (104) into the electric power;
charge itself with part of the electric power; and
forward a remaining part of the electric power via a first electric guide of the at least one electric guide to the first wearable electronic apparatus device.

11. The wearable wireless power receiver system of claim 8, further comprising a second wearable wireless power receiver configured to attach to second footwear of the person for powering the at least one wearable electronic apparatus.

12. A walkable power transmitter, comprising:
a power source;
a carrier substrate configured to adapt to a surface of a floor that is walkable by a person;
an electrically conductive material mounted on the carrier substrate and that is away from a lower limb of the person and forming at least one transmitter coil, configured to transmit an electromagnetic field for powering at least one of a first wearable electronic device or a second wearable electronic device; and
a shielding material mounted on the carrier substrate that is nearer to the lower limb of the person and configured to shield the person from at least a portion of the electromagnetic field.

13. The walkable power transmitter of claim 12, wherein the shielding material is further configured to shield the surface and the power transmitter from each other.

14. The walkable power transmitter of claim 12, wherein the carrier substrate is further configured to be embedded in a mat on the floor.

15. The walkable power transmitter of claim 12, wherein the carrier substrate is further configured to:
extend over a first region of a first foot of the person; and
extend over a second region of a second foot of the person.

16. The walkable power transmitter of claim 12, wherein the carrier substrate comprises a main plane, wherein the walkable power transmitter further comprises substrate extensions located at corners of the carrier substrate, wherein the substrate extensions extends at a height with respect to the main plane, and wherein the at least one transmitter coil is formed on the carrier substrate and on the substrate extensions.

17. The walkable power transmitter of claim 12, further comprising a flexible mat comprising the carrier substrate, wherein the flexible mat is configured to be rolled or folded, and wherein the power source is attached on an outside surface of the flexible mat.

18. The walkable power transmitter of claim 12, wherein the at least one transmitter coil is further configured to generate at least two charging hotspots for powering at least one of the at least the first wearable electronic device or the second wearable electronic device.

19. The walkable power transmitter of claim 12, wherein the carrier substrate is further configured to be removably attached to a bottom part of footwear of the person.

20. The walkable power transmitter of claim 12, wherein the carrier substrate is further configured to be embedded into an outsole of footwear of the person.

21. The walkable power transmitter of claim 12, wherein the carrier substrate is further configured to be embedded into the floor.

22. The wearable wireless power receiver system of claim 10, wherein the wearable coupled resonator array is further configured to:
extend from the lower limb to a location of the at least one wearable electronic apparatus;
transmit the electromagnetic field; and
relay an electromagnetic field from the lower limb to the at least one wearable electronic apparatus.
